(19) United States
(12) Patent Application Publication
(10) Pub. No.: US 2013/0122807 A1
(43) Pub. Date: May 16, 2013

(54) SYSTEMS AND METHODS FOR EFFECTING GOOD HYGIENE PRACTICES

(71) Applicant: Versus Technology, Inc., Traverse City, MI (US)

(72) Inventors: Henry J. Tenarvitz, Suttons Bay, MI (US); Gary Gaisser, Kingsley, MI (US)

(73) Assignee: VERSUS TECHNOLOGY, INC., Traverse City, MI (US)

(21) Appl. No.: 13/671,303

(22) Filed: Nov. 7, 2012

Related U.S. Application Data
(60) Provisional application No. 61/557,163, filed on Nov. 8, 2011.

(51) Int. Cl. H04B 5/00

(52) U.S. Cl. CPC H04B 5/0031
USPC 455/41.1

(57) ABSTRACT

A networked system and method for improving hygiene practices includes an interactive communication system of user devices and an information engine. Wired and wireless data transmission methods are provided.

### CROSS REFERENCE TO RELATED APPLICATION

The present application claims the benefit from earlier filed U.S. Provisional Patent Application No. 61/557,163 filed Nov. 8, 2011, which is incorporated herein in its entirety by reference.

### BACKGROUND OF THE INVENTION

(1) Field of the Invention

The present invention relates generally to a system and a method for maintaining, promoting, monitoring and enforcing good hygiene practices in institutional environments. For simplicity the system and method will be termed “hygiene compliance.” Good hygiene practices, such as hand-antisepsis and wearing of protective garments, are necessary to maintain safety, and it is useful to have an enforceable system for persons to perform such personal hygiene tasks. Healthcare-associated infections (HAI) lead to greater than a billion dollars in excess healthcare costs annually, which is occurring within an economic environment that is charged with improving patient safety and quality while reducing healthcare costs. Further, pursuant to Deficit Reduction Act (DRA) of 2005 §5001(c), the Secretary of Health & Human Services to identify, and reduce payments for, conditions that are: (a) high cost or high volume or both, (b) result in the assignment of a case to a DRG that has a higher payment when present as a secondary diagnosis, and (c) could reasonably have been prevented through the application of evidence-based guidelines. HAIs, thus, exert both a human and economic toll.

Despite recognition of the problem and prior implementation of various hygiene-education and disinfection programs, HAI rates remain unacceptably high. Moreover, HAI creates a dilemma for health-care management, because of the worldwide problem of evolving, multi-drug resistant bacteria and the increasing complexity of the healthcare environment. However, the prevailing view is that many HAIs are preventable complications, a view highlighted by the Centers for Medicaid and Medicare Services (CMS) decision that preventable complications, such as vascular-catheter-associated infections, will no longer be reimbursed by Medicare. Other infections may follow.

The etiology of HAIs in health-care settings is explained at least in part by bacterial cross contamination, which is generally believed to be a consequence of poor compliance with best hand hygiene practices. Multimodal intervention strategies have been shown to be more effective than single intervention approaches, but more effective ways must be found to implement such strategies.

It is well known that disease and infection is often transferred from one person to another as a consequence of poor hand hygiene practices by one or more persons in a chain of transmission. The issue is most pronounced in the healthcare industry, including hospitals, care homes and hospices, where visitors and caregivers, including nurses, doctors and therapists, should cleanse their hands regularly. This is especially critical when the persons are moving between treating different patients. Indeed, even patients should be encouraged to be hygienic whenever they exit their room. But the problem is not limited to healthcare institutions. Possibilities for transmitting germs from one person to another are also significant in the hospitality industry where employees have contact with food, service ware, bedding and the public. Schools, day care centers and offices have similar issues. Other environments may also require regular hand hygiene. The environments where good hygienic practices are desirable and should be encouraged are generically referred here as “institutions,” and the term includes healthcare facilities such as hospitals, care homes and hospices; facilities involving food handling, such as agricultural facilities, food-processing facilities, catering facilities and restaurants; hospitality facilities, such as hotels and motels; and childcare facilities such as day care centers and schools. All persons within an institution are users of the facility and should be encouraged to maintain good hygienic practices, and, thus, the term “users” is intended to cover all persons within an institution, whether they are employees, third-party contractors, visitors, patients, students or have other reasons for being within an institution.

Healthcare-associated infections (HAI) are defined as infections not present and without evidence of incubation at the time of admission to a healthcare setting. Within hours after admission, a patient's flora begins to acquire characteristics of the surrounding bacterial pool. It is estimated that in the U.S. alone, there are over 2,000,000 HAIs each year. They conservatively cost $17 billion dollars to resolve and result in 100,000 deaths per year, and nearly one third of these are attributable to poor hand hygiene. Thus, HAIs extract a very high price from society in terms of human pain and suffering as well as treatment and legal costs. Surveillance, along with sound infection control programs, not only lead to decreased healthcare-associated infections but also better prioritization of resources and efforts to improving medical care, and programs in health-care institutions to control healthcare-associated infections have been in place since the 1950s. Nevertheless, it is believed that a far more significant portion of these HAIs can be prevented if health care providers practice proper hand hygiene. Indeed, the Centers for Disease Control recognizes that improved hand hygiene compliance with standards for infection control practice is a key to substantially reducing healthcare-associated infections.

Infectious microbes that can be acquired or transmitted in a healthcare setting include: Acinetobacter baumannii; Burkholderia cepacia; chickenpox (varicella); C DIFF (Clostridium difficile); Clostridium sordellii; Creutzfeldt-Jakob Disease (CJD); ebola virus (viral Hemorrhagic Fever); hepatitis viruses A and B; influenzaviruses; MRSA (methicillin-resistant Staphylococcus aureus); mumps; norovirus; streptococcal species; Pseudomonas Aeruginosa; parvovirus; poliovirus; pneumonia; rubella; SARS; S. pneumoniae; tuberculosis; VISA (vancomycin intermediate Staphylococcus aureus); and VRE (vancomycin-resistant enterococci). MRSA is a type of staph bacteria that is resistant to certain antibiotics called beta-lactams. These antibiotics include methicillin and other more common antibiotics such as oxacillin, penicillin, and amoxicillin. The more severe or potentially life-threatening MRSA infections occur most frequently among patients in healthcare settings. Reducing MRSA in healthcare and other institutions had become a high priority, and recent data indicates that MRSA can be controlled to at least some extent by proper hygienic policies. In 2010, a CDC study showed that invasive (life-threatening) MRSA infections in healthcare settings declined 28% from 2005 through 2008. In addition, the study showed a 17% drop in invasive MRSA infections that were diagnosed before hospital admissions (community onset) in people with recent exposures to healthcare settings.

However, practicing proper hygiene is a difficult task. The failure of workers to employ good hand hygiene practices results from a confluence of factors including lack of knowledge of standards, apathy, time pressures, resistance to change, and perceived inconvenient location of hand disinfection dispensing apparatuses for hand hygiene. Proper hygiene requires compliance to strict rules that demand frequent antisepsis. The major challenge faced by caregivers is that the use of these agents in the quantities and the frequencies necessary to adhere to commonly accepted hand hygiene guidelines results in dangerous and painful degradation of the skin on the users' hands. Resistant strains of pathogens such as MRSA and C DIFF particularly now dictate the use of the harsh rubs and soaps. Following their use, caregivers are encouraged to utilize a secondary skin conditioning agent immediately thereafter to protect their skin from damage.

New systems and methods designed to encourage, effect, monitor and enforce hand sanitation and other hygienic practices are needed to reduce the spread of infectious microbes in institutions. While the healthcare industry is primarily addressed here, the problems and resultant solutions presented are applicable to a range of industries and service organizations.

(2) Description of Related Art

While the need for good hand hygiene has been well known and documented in the past, it is also well-documented that good hand hygiene behavior—like many health behaviors—is difficult to consistently undertake and maintain. The many systems known in the art to encourage, effect, monitor and enforce hand sanitation and other hygienic practices include:

The Versus Advantages™, described at http://www.versustech.com/technology.html, is a well-known health-management and compliance system. It is a real-time clinical location, automation and awareness tool, which combines locating technology with rules-based software to enable caregivers and administrators to view, share and report information to assist in monitoring and enforcing hygiene standards. The system disclosed above may be supplemented by disclosures found in U.S. Patent Application publications 201101224, Context-Aware Method And System For Facilitating The Delivery Of Healthcare To Patients Within A Clinical Environment Monitored By Real-Time Locating Apparatus; 201101213, Real-Time Method And System For Controlling Healthcare Delivery Processes Within A Clinical Environment; 20110121974, Real-Time Method And System For Monitoring Hygiene Compliance Within A Tracking Environment; 20110121962, Real-Time Method And System For Locating A Mobile Object Or Person In A Tracking Environment While Conserving Electrical Energy In A Battery-Operated Tracking Tag Associated With The Object Or Person; and 20040183682, Methods And Systems For Locating Subjects And Providing Event Notification Within A Tracking Environment And Badge For Use Therein.

A related system is described at http://www.radianse.com, and that disclosed system may be supplemented by disclosures found in U.S. Pat. Nos. 7,099,895; 7,403,111; 7,567,794; 7,053,831; 7,443,300; and U.S. Patent Application publications 20090198734 and 20090184823.

Hygiene monitoring systems are also disclosed in patents issued to Hill-Rom Services, Inc., including U.S. Pat. No. 7,734,4 to Wildman et al., Universal Communications, Monitoring, Tracking, And Control System For A Healthcare Facility, issued Jun. 8, 2010; U.S. Pat. No. 7,907,053 to Wildman et al., Combined Locating, Tracking And Communications System, issued Mar. 15, 2011; and U.S. Pat. No. 7,812,730 to Wildman et al., Hygiene Monitoring System, issued Oct. 12, 2010.

Other examples of disclosed technology include U.S. Pat. No. 5,952,924, filed on Dec. 4, 1997, which describes a system that comprises a housing located in the sanitation area for receiving at least a portion of the hands of the worker. A detector is operatively associated with the housing. The detector detects whether or not the hands of the worker have recently been washed in response to the insertion of the hands of the worker into the housing. A communication media is also operatively associated with the detector for outputting one of a sanitary signaling media in response to the detection that the hands of the worker have been washed and an unsanitary signaling media in response to the detection that the hands of the worker have not been washed.

Another example is described in UK Patent Application No. GB 2417811A, filed on Aug. 12, 2005, that discloses hand hygiene detector device, suitable to be fitted to a person possibly on the hand or wrist, comprises a receiver for sensing a hand washing event and a timing module responsive to the receiver. The device may also include an alarm system wherein the timing module activates the alarm system when a first predetermined time limit is exceeded between hand washing events. The alarm may be audible, vibratory and/or visual and the receiver may detect the presence of water or any other chemical present during hand washing. The device may help in infection control by monitoring hand washing and reminding people to wash their hands regularly.

Another example is U.S. Patent Application publication 20100188228 to Hyland, published Jul. 29, 2010, which describes a system and a method of monitoring hygiene standards compliance in a medical facility in which there is provided a surveillance network having a monitoring unit and a plurality of network units. There may additionally be provided a plurality of fixed network units. The monitoring unit, mobile network units and fixed network units are connected by way of a wireless personal area network (WPAN), in this case a ZigBee network. Identification signals are sent from the mobiles network units to the monitoring unit and the monitoring unit stores the identification signals in memory and generates a hygiene standards compliance profile for an individual associated with a particular mobile network unit. The hygiene compliance profile may provide information relating to the number of times that a particular individual washed their hands to information regarding the patients that that individual came into contact with over the course of a shift. Reports on the behavior of individuals or groups of individuals may be generated.

Another example, U.S. Patent Application publication 20090324444 to Stratmann, Door Opening System, that discloses a system comprising: a) a hand sanitizer dispensing unit that dispenses a hand sanitizer upon activation; b) a door with a door opening device; c) an electrical, mechanical, or wireless signal connection between said hand sanitizer dispensing unit and said door opening device; and d) a manual override device, wherein said hand sanitizer dispensing unit transmits an activation signal to said door opening device upon activation, wherein said door opening device opens said door upon receipt of said activation signal, and wherein use of said manual override device allows bidirectional movement of said door independent of said activation of said hand sanitizer dispensing unit.

It has been suggested in United States Patent Application Publication 20110201270 (Aug. 18, 2011) (Awarepoint Corporation) that NFC could be used for a wireless tracking mesh network, and stated that the “present invention utilizes near-field communication devices in conjunction with tracking tags to transmit signals for reception by sensors stationed throughout a facility which form a mesh network and forward the signals to an information engine for analysis.” And, further, that “In another embodiment, the near-field communication interaction is utilized to track proper hand hygiene at a hospital. In this example, a near-field device 59 is positioned near a hand hygiene station for sterilizing hospital personal prior to surgery or similar procedures that require sterilization. When a bearer of a near field device . . . sterilizes his/her hands at the station, the interaction of the near-field devices . . . is recorded and transmitted to a sensor . . . for recordation at an information engine . . . . In this manner, the hospital has a record to demonstrate that proper sterilization was performed prior to surgery or similar procedure requiring sterilization.” Thus, this reference simply substituted the Near-Field for other wireless systems well-known in the art to locate the presence of a user near a wash-basin.

Other systems are described in United States Patent Application publication 20100328443 to Lynam et al. published Dec. 30, 2010.

### BRIEF SUMMARY OF THE INVENTION

A primary aspect of the invention to provide a system and method for effecting good hygiene practices to achieve highest possible safety levels in institutional environments. It is also an object of at least some embodiments of the present invention to provide an improved real-time method and system for controlling healthcare delivery processes within a clinical environment, and, preferably, to increase the efficiency and safety of common healthcare delivery processes in a clinical setting by collecting a real-time system (RTS) location and other data as well as other event data by providing a method and system to define and monitor common healthcare delivery processes involving mobile, tag-wearing users that increase the efficiency of delivery and the safety of each process; while being simple and inexpensive to operate and maintain; require no special training for clinical staff; and that leverages common, pre-existing communication infrastructure, when possible.

It is also an object of this invention to present the user with a system that will render hygiene compliance simple, effective and convenient, and thus reduce the barriers to compliance.

Specific embodiments of the present invention are described below. In carrying out the above-described objects of the present invention, a real-time system and method of controlling healthcare delivery processes within an institutional environment monitored by real-time monitoring apparatus including identification tags is provided. The system of the invention may also include a plurality of hygiene stations, each in communication with the real-time system. In some embodiments of the systems, the linked hygiene station is located within the patient zone. In another embodiment, a hygiene station is located at the portal to the patient area and controls access by a user into and/or from the patient area.

The system and method may also include a set of rules which are predefined so as to be representative of a combination of event data and subject data values occurring when the healthcare delivery processes are performing optimally. The system and method may still further include performing at least one corrective action to improve the performance of at least one of the processes if a measured performance. For example, the system of the invention may associate a hygiene protocol for use in a patient area, including associating a selected patient with a patient zone; identifying a patient-based factor associated with the selected patient; selecting a hygiene protocol to apply in the patient zone based on the identified patient-based factor; and applying the selected hygiene protocol upon entry of a transient credential into the patient zone. In such embodiments, the patient-based factor may be based on the infectious agents to which the patient has been exposed.

The system and method further includes evaluating in real-time the event data and subject data based on the set of predefined rules to measure performance of the processes. The step of performing may be predefined by the set of rules. The step of performing may include communicating an audio, vibrating or video alert to a device. The alert may be a video alert comprising a text or graphical alert. The step of performing may include communicating a report to a device. The step of performing may include communicating a message to a device. The step of performing may include communicating an activation signal to a device.

The present invention will now be described in the following detailed description of the invention, in which some, but not all embodiments of the invention are described. The previously-stated objectives and other features and advantages of the present invention, will become readily apparent from this detailed description when taken in connection with the accompanying drawings and the ordinary skill in the art. However, the detailed description is not intended to limit the scope of the invention as set forth by each particular claim. The various aspects of the system of the invention detailed below may be embodied in many different forms and should not be construed as limited to the embodiments set forth below.

It is also to be understood that support for the various applications or portions thereof thereby, can appear throughout the text and/or drawings at one or more locations, irrespective of the section headings. At least certain portions of the text of this disclosure (including claims, detailed description, and/or drawings) can support various different claim groupings and/or various different applications. Thus, the detailed description may include section headings that generally track various different concepts associated with claims or general concepts contained in this disclosure for sake of convenience and understanding.

It is also noted that a person skilled in the art will also appreciate that development of any actual implementation, as in any engineering or design project, requires numerous implementation-specific decisions to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

### BRIEF DESCRIPTION OF THE DRAWINGS

For a fuller understanding of the nature and objects of the invention, reference should be had to the following detailed description taken in connection with the accompanying drawings. For a complete understanding of the structure and method of the invention, reference should be made to the following detailed description and accompanying drawings wherein:

FIG. 1 is a block diagram of an embodiment of an online system of the invention;

FIG. 2 is a block diagram of an embodiment of a tag communicating with a receiver in one implementation of the invention;

FIGS. 3-11 are schematic views of a hand hygiene system; and

FIG. 12 is a view of a report.

### DETAILED DESCRIPTION OF THE INVENTION

### A. Definitions

The below terms used in this disclosure are defined as follows:

“Institution” refers to any environment where hygienic practices are desirable, and include the typical health-care environments such as hospitals, clinics, care homes and hospices; food-handling environments such as agricultural facilities, food processing facilities, restaurants, catering environments and fresh food areas of supermarkets; hospitality facilities, such as hotels and motels; childcare facilities such as day care centers; schools; and airports.

“User” refers to all persons within an institution who should be encouraged to maintain good hygienic practices, and, thus, the term users is intended to cover all persons within an institution, whether they are employees, third-party contractors, caregivers, visitors, patients, teachers, students or have other reasons for being within an institution, and include in particular all persons who should timely and appropriately wash their hands to reduce the risk of spread of infectious agents.

“Object” refers to a physical object, which is not a User. It may be an item of equipment.

“Protocol” refers to a set of conventions governing the format and control of interaction among communicating functional units, and in general permitting devices and information systems to exchange data or information. Protocol may include semantic and syntactic rules that determine the behavior of entities in performing communication functions. Protocols may govern portions of a network, types of service, or administrative procedures. For example, a data link protocol is the specification of methods whereby data communications over a data link are performed in terms of the particular transmission mode, control procedures, and recovery procedures. Protocols include the specific modulation formats and frequencies associated with the modulation formats.

“Transceiver” refers to a device that performs, within a common housing or structure (such as a chassis or chip), both transmitting and receiving functions, preferably using a common circuit components for both transmitting and receiving, and providing at least half-duplex operation.

“Multi-modal” refers to operability using different protocols, which may include one or more of different modulation schemes, different frequencies and different standards.

“Cleaning agent” refers to a substance used cleanse a part of a body, such as hands, or an article, such as a medical cart, for hygienic purposes, and particularly for controlling the quantity of infectious agents on the skin of a user or on the object. Any product that includes compounds that possess a cleaning action is a cleaning agent. A cleaning agent includes, but is not limited to, water-based and waterless compositions. The term generally encompasses hand rubs; antimicrobial and/or antiseptic soaps; detergents; soaps; waterless antiseptic agents; and surgical hand scrubs. A cleaning agent may be in the form of a solid (i.e., bar of soap, surgical prep sponge), powder, liquid, cream, spray, gel, or the like. An alcohol-based hand rub is an alcohol-containing preparation designed for application to the hands for reducing the number of viable microorganisms on the hands. An antimicrobial soap refers to a product comprising soap or detergent and an antiseptic agent. A detergent or soap is a product that includes compounds that possess a cleaning action. They are composed of both hydrophilic and lipophilic parts and can be divided into four groups: anionic, cationic, amphoteric, and nonionic detergents. Although products used for hand hygiene or antiseptic hand wash in health-care settings represent various types of detergents, the term “soap” also refers to such detergents.

“Antiseptic agent” refers to a waterless a cleaning agent that incorporates antimicrobial substances that are applied to the skin to reduce the number of microbial flora

“Soap” refers to a detergent-based agent without antimicrobial properties. Action is achieved by physically removing dirt and microorganisms.

“Alcohol-based” refers to a waterless, alcohol-containing agent that kills microorganisms but does not physically remove soil or organic material.

“Antimicrobial soap” refers to an agent that possesses bactericidal activity against skin flora. Action is achieved via (1) physical removal of dirt and pathogens and (2) killing of pathogens.

“Hand hygiene” refers to cleansing hands, including removing pathogens on the hands, which encompasses the use of an antiseptic agent to perform hand antisepsis.

“Hand washing” refers to cleansing hands by use of water and soap to generate lather and rinse off soluble materials, but not intended to perform hand antisepsis.

“Protective agent” refers to a substance used to protect parts of a body from the effects of harsh cleaning agents.

“Drying agent” refers to a substance used to dry a part of a body of a user or an object.

### B. Hygiene Monitoring System

A hygiene monitoring system of the invention comprises in the preferred embodiment a method and system wherein rules are defined in terms of conditional results derived from event data and subject data values. The rules are continually evaluated in respect to the most recent event and subject data values to measure the performance of each clinical process corresponding to each rule. Actions are taken in real time to correct the performance of any clinical process performance that is below that indicated in the rules design.

The method includes providing a tag or a badge that provides real-time locating and user identification, and which may permit signaling and communication of other information. Signaling and communication can utilize various technologies and all technologies can be combined in any particular system in a multitude of different implementations.

The several parts of the preferred embodiment are considered below.

### 1 System Architecture

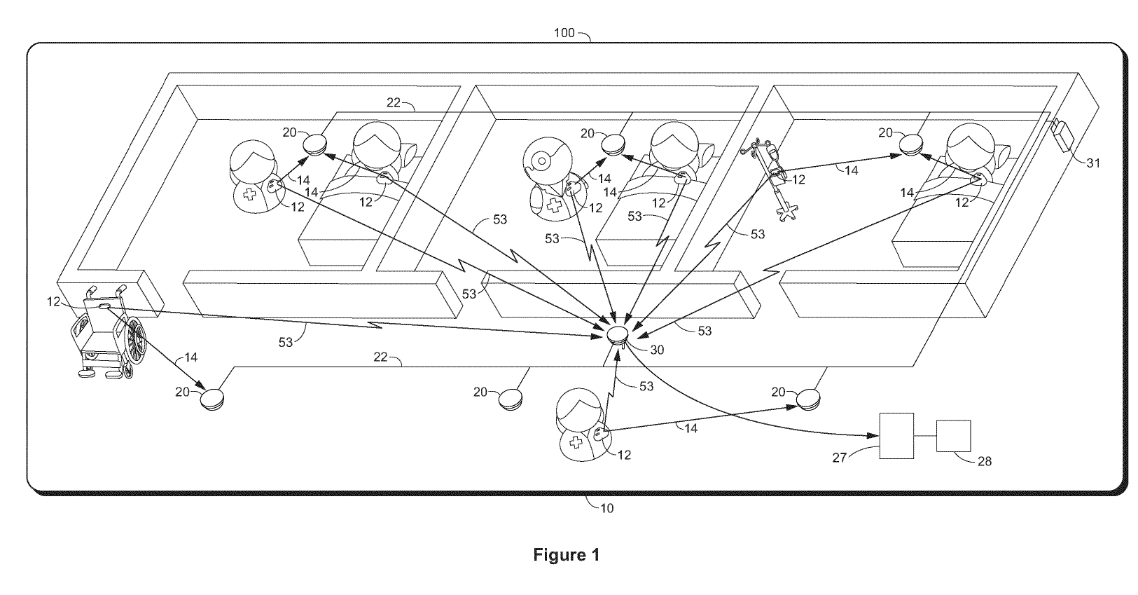

As shown in FIG. 1, a networked system for tracking events, users and objects within an institution is generally designated 100. As shown in FIG. 1, the institution is depicted as a hospital, but may be any other institution. The institution has multiple patient areas, which can be on different floors, with each patient area accessible through an opening or a door. Referring specifically now to FIG. 1, there is illustrated a real-time tracking system, generally indicated as 100, which may also be used to capture location change and alert events of each tag-wearing subject. Generally, the system 100 is comprised of tags 12 (worn by users or attached to objects) which emit signals which are captured by sensors or receivers 20 common to the tracking system.

The system 100 preferably includes a plurality of user and object real-time communication devices (termed tags) 12, a plurality of receivers 20, a plurality of collectors or bridges 30 connecting the receivers 20 to a server 27, and at least one information engine 28.

The system may include central processing or multiple localizations of information processing. In the centralized information processing system, tags 12 transmitting data to a central location where computation is performed to determine the location of each tag and process any other information. Such central computation does generate some communication costs and inherent delay. The alternative distributed localization methods may be configured in any combination of information processing. Each node in the distributed system, such as sensor or receiver 20, bridge or collector 30, or other intermediate node, may include an information engine 28 to process information such as determining the location of a tag or whether the tag bearer is complying with the required hygiene regime. The intermediate nodes process information and then further communicate only necessary limited information downstream.

The networked system 100 is capable of analyzing an interaction between objects, users and/or events. The tags 12 are attached to, or associated with, users and objects, and preferably transmit wireless signals which are received by the receivers 20, which then transmit signals to bridges 30 for eventual transmission to the information engine 28. The receivers 20 form a network for receiving signals from the tags 12. As shown in FIG. 1, the system 100 utilizes receivers positioned throughout the institution to monitor and identify the real-time events and position of users and objects. The receivers communicate with each other and with an information engine. Receivers 20 can be connected to the network either by wire or connect by wireless communication. Wired communication can utilize existing or specially implemented LAN, intranet or internet wired communications. Exchange of data is typically accomplished via a Local Area Network (LAN) that may be connected to the Enterprise Network (Intranet). Wireless format can be the medium range wireless communication format such as ZIGBEE, Bluetooth, Low-Power BlueTooth communication format, Wi-Fi, Low-Power Wi-Fi, Ultra Wide Band, Ultrasound communication format or Infrared communication format. A bridge for receiving transmissions from the receivers for forwarding to the information engine may be used.

The information engine 28 is preferably located on-site at the institution. However, the on-site information engine may also be substituted by, or be supplemented with, an off-site information engine. The information engine includes memory, a processing unit and software stored in the memory. The software when executed by the processing unit generally causes the information engine to monitor users and objects within the facility locate, and to monitor compliance with hygiene policy or regime defined for the institution. For example, the information engine is operable to cause the issuance of alerts, and can cause the system to generate a compliance report. The information engine also communicates with receivers and other devices, such as the hygiene carts.

Thus, the hygiene compliance system of the invention includes in its preferred embodiment a real-time locating tag in a real-time location communication environment; a means of storing and/or retrieving the current and historic values of all location and other pertinent data events associated with each subject's unique ID tag; a processor means for continual evaluation of each rule in respect to the current data values stored for each event associated with each tag represented in each rule and performing the actions that may be associated with the specific values that may result from the evaluation of each rule. The system consists of a number of concurrent processes. These include a tracking process to collect tag information in real time, a messaging process to collect or issue non-tag data messages such as those pertinent to each tag, an evaluation process to continually evaluate each rule respective to the current values stored or pointed to in the tag database and execute actions, if indicated.

### 2 Tags

A hygiene compliance system of the invention may comprise a generally mobile tag 12, and a receiver 20 which is usually in a fixed location, and communication between the tag and the receiver 14. The tags 12 are generally worn by users to be monitored, and are attached to objects to be monitored. The tags 12 are generally operable to communicate identification information to the receivers 20.

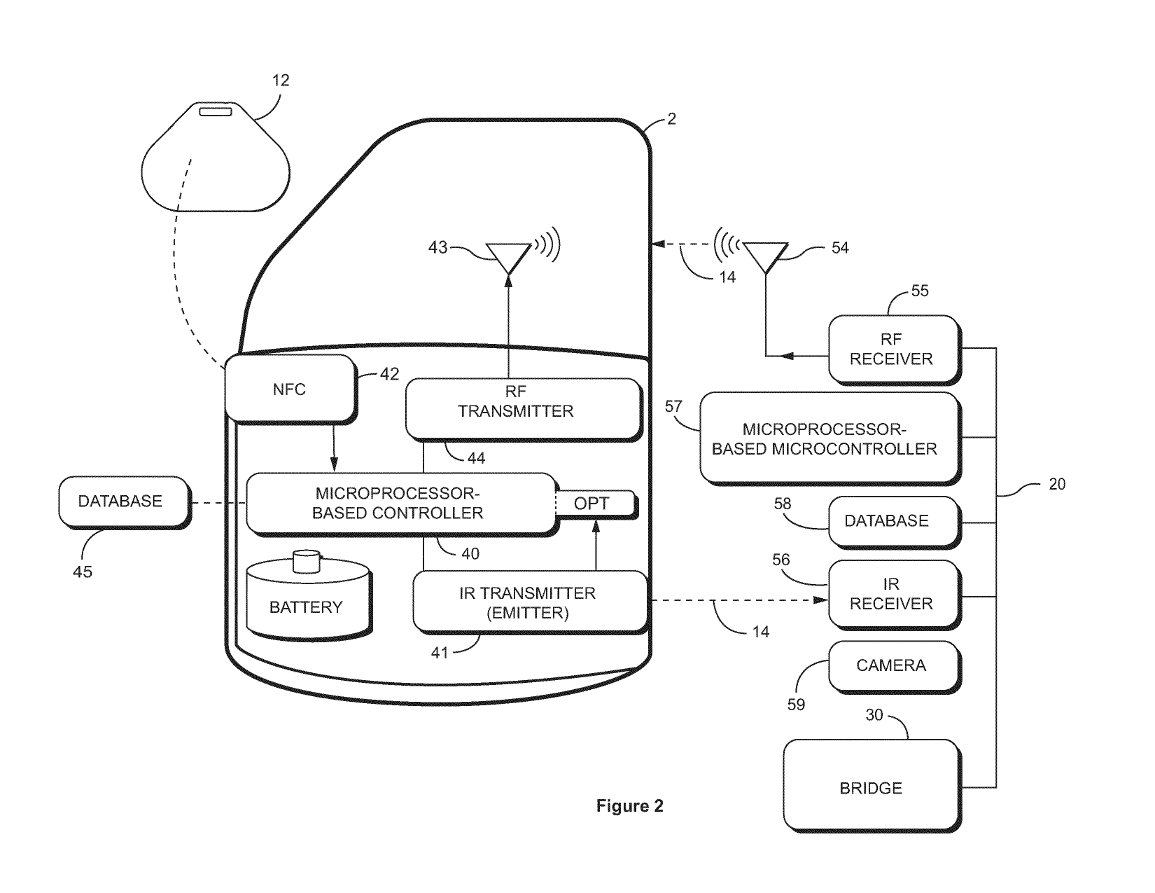

Tags may serve different functions and be associated with either users or objects. As shown in FIG. 2, tags 12 and the receivers 20 generally each include a transmitter, a receiver, a combination transmitter and receiver, a transceiver, a transponder or other receiving or transmitting mechanisms suitable for communicating identification information between the tags and the receivers.

For purposes of unidirectional and bidirectional communication of data or other signaling 14 between tags 12 and receiver 20, several formats/protocols exist, and may be utilized in the present invention. The system may utilize tags using different technologies or tags combining different technologies. For example, as further discussed below, near-field technology (“NFC”) has the benefit of consuming less power than other technologies and its short range permits precise location. However, NFC's short range becomes problematic when attempting to locate users or objects that are not within close proximity to an NFC receiver. Therefore, tags combining technologies, such as IR/RF and NFC, or multiple tags using different technologies, such as IR/RF and NFC, may be helpful in a given system 100. The IR/RF and NFC tags may be the same physical device with circuitry for all applications. The different types of functions in the tags are further detailed below.

The tag 12 may include a database 45 to store tracking processes, tag specific event data or non-tracking process subject data. Event data includes the tag's location and switch state's history. Subject data includes data or pointers to data (information needed to retrieve the data from another source) such as name, medical record number pertinent to each tag's subject.

The method optionally includes the provisions to notify the information engine 28 that other, non-location change events have occurred including but not limited to: (1) classifying specific tag IDs into one or more tag types groups such as a “doctor” type, “nurse” type or “patient” type; (2) implementing one or more “alert” switch(es) to the tag that may be manually or automatically activated to provide notification of an event associated to the tag that is non-location based; and (3) collecting and/or issuing external data event messages pertinent to specific tag IDs or tag type groups represented in a rule such as network messages indicating new patient orders, the results of pending patient orders, patient admission or discharge, etc.

A tag having a unique ID is provided for each subject to be tracked within the tracking environment. The size of the unique ID component of the data packet transmitted by the tag determines the total number of unique tag IDs available in the tracking environment and is dictated by the total number of unique subjects present in the tracking environment.

The tags may additionally include one or more accelerometers to sense the movement or orientation of the tag. The accelerometers may provide input or feedback regarding the movement of the tag, and, thus, the user or object with which it is associated. By way of example, the accelerometers may include a 3-axis accelerometer from ST Microelectronics.

The tag is bi-directional. The tag may be programmed with data, and may communicate data. Thus, for example, upon admission to an institution (for example, a hospital), a user (for example, a patient) can be associated with a tag which is programmed with defined vital information. The tag can be in the form of a typical wrist-bank identification tag commonly used in hospitals. As detailed below, the tag can utilize near-field communication (NFC). An NFC tag can be programmed with the data by abutting the tag to another NFC device operable to exchange information with another NFC tag.

A tag 12 may include a sensor to receive information from a receiver 20, and may be configured to transmit information based upon the input from a receiver 20. Alternatively, the tag 12 or receiver 20 may be designed to sense a particular environment, such as a signal from a device, recognition of gases, noise vibration or particular radio frequency ranges.

Tag 12 of the present invention will include elements known in the art and generally found in all communication devices, whether individually or part of an integrated circuit or microcontroller, and including elements integrated into a single chip. These elements may include a battery, antenna interfaces, antenna(s), modulators, demodulators, transceivers, duplexers, RF switches, filter, I/Os, UARTs, interrupts, memory, modems and the like, and the code to operate the device elements.

### 2.a IR/RF

Referring to FIG. 1, in the illustrated a real-time tracking system, generally indicated as 100, the signaling tag 12 can be designed to communicate by various technologies and protocols. In one embodiment, the tag 12 emits infrared (IR) and/or radio frequency (RF) signals. Such tag 12 includes a microchip, microprocessor-based controller 40, and an infrared (IR) transmitter 41 which transmits an identification signal, which may include, for example an identification code specific to the person wearing the tag. In the more preferred embodiment, each tag 12 emits infrared light via an IR transmitter or LED, containing digitally encoded data generated by using the microprocessor to apply a size reduction function or algorithm to the RF data packet. This is done to avoid the high power consumption required to simply retransmit the identical RF data packet via the IR LED. The IR transmitter transmits the identification signal to information engine 28 via the receivers 20. For example, the IR transmitter of a tag transmits the identification signal to an IR receiver of a receiver 20. The receiver then provides the information received via the identification signal to the information engine for further processing and recording.

Each tag 12 may further include an RF transmitter 44 which also transmits the identification signal to the information engine 28. The advantage of transmitting using both the IR and RF transmitters is that if the IR transmitter becomes obscured the RF signal should still be detectable. The RF transmitter may also be used to transmit an alert signal in response to the pressing of a button on the tag.

Each tag 12 may further include an RF receiver that is operable to receive a signal from the information engine. The tag is operable to activate either a visual, audible or tactile alert indicator.

The IR or RF signal may be modulated to represent each tag's unique ID number. Each user's or object's identification data is associated with each unique tag number. The provision of this tag in a tracking environment allows the information engine to associate unique tag data with the particular location and the time it was seen at that location.

Each tag transmits a radio frequency (i.e. RF) signal via an antenna 16, containing a data packet with at least the unique tag ID, in a substantially spherical pattern. The radio frequency signals emitted by the antennas are received by an antenna of a radio frequency receiver having a range of approximately 100 feet in all directions. The radio frequency receiver converts encoded signals emitted by the tag into electrical signals and transmits them via the serial network.

The embodiment of the system 100 also includes a receiver assembly including a plurality of infrared receivers which are utilized to receive the tags' infrared signals and transmit coded data via the network. Each infrared receiver on the network has internally assigned a two digit identifier typically starting with the number one then incremented by one for each successive infrared receiver on the network. Thus, the two digit identifier represents the unique location monitored by each infrared receiver on this serial network. Typically, the effective line-of-sight range of such infrared signals is about a 20 meter diameter. To achieve higher granularity within the system, the infrared receiver may have its field of view reduced to as little as a 1 meter diameter by introducing a restrictor in the IR receiver. The infrared receiver reads the encoded signals emitted by the IR transmitter, appends the encoded two digit identifier, then converts the entire combination to electrical signals which are transmitted via the network.

The RF signal is sent via an antenna and contains a data packet with at least the 4 byte ID data space providing 4,294,967,296 unique tag IDs. Additionally the RF data packet may generate error checking data and tag qualifier data (e.g. battery state, motion state, alarm state) as an optional prefix and/or optional suffix to the unique Tag ID.

The IR signal emitted via the LED contains a data packet that is a result of the microprocessor having applied a size reduction function or algorithm to the RF data packet. The resulting packet is shorter than the parent RF data packet thereby reducing the amount of energy required to send the IR signal when compared to retransmitting the entire RF data packet via an IR signal.

The size reduction function may be a checksum, CRC or other function that derives a smaller number from a larger number in such a way as to increase the statistical probability of there being only one unique size reduction function result for each unique tag ID within the area covered by a radio frequency receiver.

### 2.b Radio Frequency Identification

Referring to FIG. 1, in the illustrated a real-time tracking system, generally indicated as 100, the signaling tag 12 can be designed to utilize Radio Frequency Identification (RFID) in identifying and tracking users and objects.

In one embodiment, tag 12 contains a microchip, microprocessor-based controller 40, and a RF transmitter 44 including an internal antenna 43 which operates at a certain frequency, as shown in FIG. 2. Tag 12 stores a specific ID and other user or object-related data, and sends the data to receiver 20 at certain times or upon request. The RF transmitter of tag 12 may be passive or active, according to the tag's power source. A passive tag 12 will be activated by the electromagnetic energy emitted by the receiver 20. Such passive tag 12 depend on the receiver for power to operate and consequently has a shorter read ranges and smaller data storage capacity than a comparable active tag. Active tags rely on internal batteries for power supply, which enhances the read ranges significantly and enables additional on-board memory and local sensing and processing capacities. However, the on-board power source increases the cost of the tags and limits the operating time of the tags. To bridge the gap between passive and active tags, a third type of tag, battery-assisted passive tags or semi-passive tags, have been introduced; which utilize on-board batteries to power the tags, but which are only activated when in the range of, and requested by, the receiver 20.

An RFID receiver 20 comprises an antenna 54 and a transceiver 55, and reads data from, and writes data to, tag 12. Antenna 54 establishes the communication between the tag and the transceiver, and its shape and dimensions determine the performance characteristics such as the frequency range. Larger antenna loops tend to yield wider coverage areas, but the signal-to-noise ratio decreases at the same time; therefore a careful balance in reader design must be attained between the coverage area and reception reliability.

The frequency on which the RFID system operates is another important element, which determines the characteristics of the signals traveling between reader and tags. Available frequencies include low frequency (LF), high frequency (HF), and ultra-high frequency (UHF). Super-high frequency (SHF) or microwave is also used. Presently, UHF passive tags offer simple and inexpensive solutions, and generally in the RFID area most active tags operate on UHF.

Tag 12 can be read-only or read/write; the latter enables data entry directly to the tag 12 throughout the life of the item that is attached. Receiver 20, which send RF signals for communication, is used to read data from the tag. RFID technology does not require line-of-sight, and also it is durable to harsh environments and can be embedded in concrete. Reading range depends on the frequency at which the tag operates, and it varies from several inches up to about 100 feet. Finally, RFID enables efficient automatic data collection because receivers can be mounted to any structure to detect and read tags in the reading range and each receiver can scan multiple tags at a given time. However, this technology, unless combined with other tools, can only report the radius inside which the tracked entity exists. Like most other technologies, RFID also needs a tag to be attached to each user or object entity that is being tracked. RFID's the near-sighted effect limits its use in real-time tracking applications.

Combinations of GPS, discussed below, and RFID technologies are possible. Every time a tag is located, the 3D coordinates (as reported by the GPS) can be recorded as the location of each piece of material at that given time. However, the near-sightedness of RFID still limits the applicability of such solutions for real-time component tracking.

An RFID system includes triangulation algorithms or algorithms based upon time-of-arrival or time-differences of arrival to calculate the location of the tag 12 using information from the receivers 20. Information engine 28 receives the information from the receivers 20, through any intermediate devices, and uses triangulation algorithms to calculate the location of the tag. The information from the receivers can be subjected to intermediate processing prior to receipt of the processed information by the information engine 28. The identification of the tag can be used to identify the user or object associated with the tag 12 and such information can be stored, displayed or otherwise processed including any combinations thereof by the information engine 28. The algorithm may use distance estimates such as signal strength (RSSI) or time of arrival (TDOA). The RFID can also communicate non-range contents.

RFID technology's limitations are that metals and liquids can significantly reduce the read range and lower the data transfer rate of the RFID system, due to their interference with the radio waves traveling between receivers and tags. A second problem is that the RSSI and TDOA systems are not sufficiently robust to provide accurate location information.

### 2.c Ultra Wideband

Referring to FIG. 1, in the illustrated a real-time tracking system, generally indicated as 100, the signaling tag 12 can be designed to utilize Ultra Wideband (UWB) as another type of short-range communication radio technology. The tag 12 may be the same typically active RFID tag as described above in conjunction with the RFID system, but which periodically transmits short and low power UWB bandwidth pulse signals. UWB systems can be made to accurately locate a tag in three dimensions despite signal attenuation and multiple signal pathways which generally occur in dense metal environments of hospitals and other institutions. UWB is able to provide 2- and 3-D localization even in the presence of severe multipath by detecting time-of-flight of the radio transmissions at various frequencies. Another advantage of the UWB system is the low average power requirement that results from low pulse rate. An embodiment of this technology for asset tracking system in certain radio frequency sensitive environments (e.g. hospitals) was described in R. J. Fontana, E. Richley, J. Barney, Commercialization Of An Ultra Wideband Precision Asset Location System, in: Proc. IEEE Conference on Ultra Wideband Systems and Technologies, Reston, Va., 2003, pp. 369-373, and in R. J. Fontana; Recent System Applications Of Short-Pulse Ultra-Wideband (UWB) Technology in IEEE Transactions on Microwave Theory and Techniques; Vol. 52, No. 9 (2004) pp. 2087-2104, and those described in U.S. Pat. No. 6,054,950, U.S. Pat. No. 6,882,315, U.S. Pat. No. 6,882,315 and U.S. Pat. No. 7,209,523, which are incorporated in whole by reference for their description of the UWB technology.

Generally, the system and method includes associating users and objects with a radio frequency tag 12 capable of emitting, preferably on an intermittent basis, UWB signals which signals include information identifying the tags. The signals are received by at least 2 UWB receivers 20 which are at known locations. Increasing the number of receivers, increases the accuracy of the tag's location. The method also includes communicating at least tag identification information and one or more of time-of-arrival information and angle-of-arrival information from the UWB receivers to the information engine 28.

A UWB receiver 20 includes RF sensor 56 which receives the UWB signals emitted by the tag and communicate information to a collector or bridge 30 other device for further routing or processing. Other information may comprise the UWB tag identification, time-of arrival, angle of arrival, any available environmental condition information, and combinations of them. Such communication may be wired or wireless and may be routed through intermediate devices.

A UWB signal is preferably pulsed every second or every 2 seconds, and the pulse rate is designed based upon the desired battery life of the tag 12, and the need to track movement direction and rate of the users or objects.

### 2.d Near-Field Communication

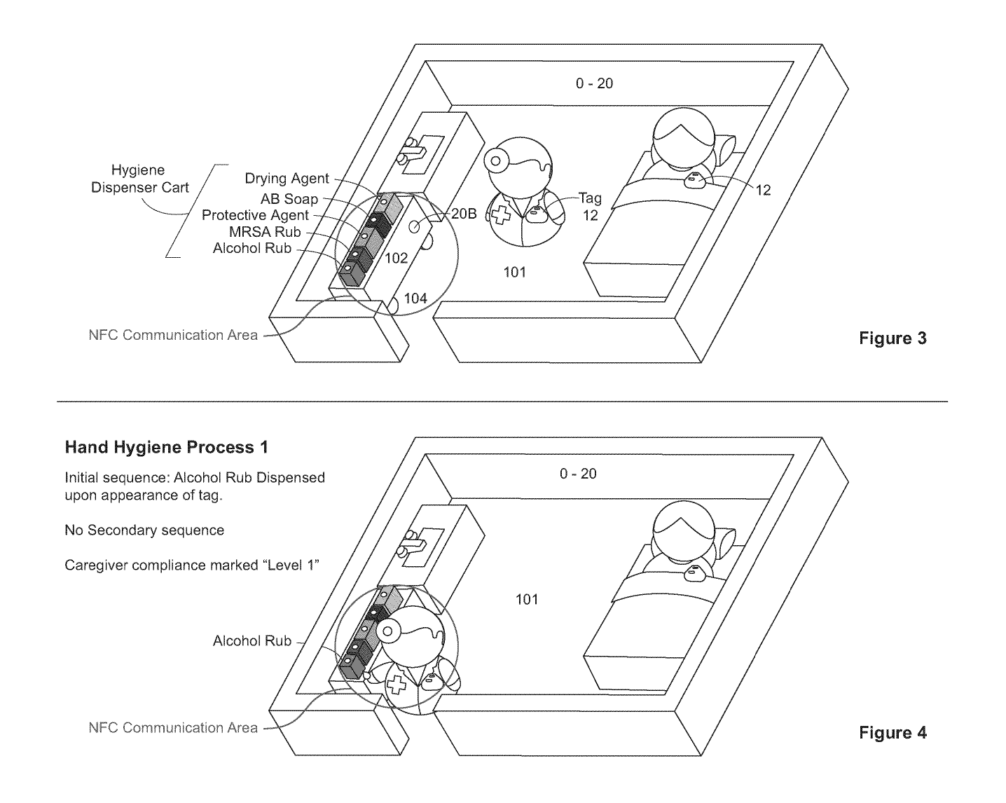

Referring to FIG. 1, in the illustrated a real-time tracking system, generally indicated as 100, the signaling tag 12 can be designed to utilize Near-field communication (NFC) technology. NFC is a standards-based, short-range wireless connectivity technology that enables simple and intuitive two-way interactions between electronic devices, and is detailed at http://www.nfc-forum.org/aboutnfc/ (last accessed as of the date of this application). NFC technology permits contactless transactions, and simplifies setup of some longer-range wireless technologies, such as Bluetooth and Wi-Fi. It is also compatible with the global contactless standards (ISO 14443 and/or ISO 18092). The NFC Forum has published the chart (FIG. 3) to compare NFC in range and speed with other wireless technologies in certain applications. By design, NFC requires close proximity and it offers instant connectivity. NFC uses magnetic induction between two loop antennas located within each other's near field, effectively forming an air-core transformer. It operates within the globally available and unlicensed radio frequency ISM band of 13.56 MHz on ISO/IEC 18000-3 air interface. Theoretical working distance with compact standard antennas: up to 20 cm (practical working distance of about 4 centimeters) Supported data rates: 106, 212 or 424 Kbit/s (the bit rate 848 Kbit/s is not compliant with the standard ISO/IEC 18092) There are two modes: Passive communication mode and Active communication mode. In the former mode, the initiator device provides a carrier fields and the target device answers by modulating the existing field. In this mode, the target device may draw its operating power from the initiator-provided electromagnetic field, thus making the target device a transponder. NFC always involves an initiator and a target; the initiator actively generates an RF field that can power a passive target. This enables NFC targets to take very simple form factors such as tags, stickers, key fobs, or cards that do not require batteries. NFC peer-to-peer communication is of course possible, where both devices are powered. In the Active communication mode, both initiator and target device communicate by alternately generating their own fields. A device deactivates its RF field while it is waiting for data. In this mode, both devices typically have power supplies.

NFC tags 12 contain data and are typically read-only but may be rewriteable. Tag 12 can be custom-encoded or use the specifications provided by the NFC Forum, an industry association charged with promoting the technology and setting key standards. The tags can securely store personal data among other information. The NFC Forum defines four types of tags which provide different communication speeds and capabilities in terms of configurability, memory, security, data retention and write endurance. Currently available NFC Tags offer between 96 and 512 bytes of memory.

NFC employs two different codings to transfer data. If an active device transfers data at 106 Kbit/s, a modified Miller coding with 100% modulation is used. In all other cases Manchester coding is used with a modulation ratio of 10%. NFC devices are able to receive and transmit data at the same time. Thus, they can check for potential collisions if the received signal frequency does not match with the transmitted signal's frequency.

NFC operates at slower speeds than Bluetooth, but consumes far less power and doesn't require pairing.

NFC provides a low-power wireless interaction tracking and detection circuit that triggers a higher-power communication system that can transfer more meaningful data after an interaction event has been detected. The NFC tags are attached or associated with users, although they may also be used with objects. The NFC tags transmit a beacon signal using a short range wireless communication format receivable by another NFC device when the NFC devices are within physical proximity of each other. NFC devices may exchange short bits of information between themselves, receivers or other devices, but such an exchange is not mandatory. At least one of the NFC devices transmits interaction data using a wired or a medium- or long-range wireless communication format to the institution's network.

The NFC devices preferably continuously transmit signals on a predetermined time cycle, and these signals are received by NFC receivers positioned throughout the institution. Alternatively, the NFC devices transmit signals in a random, ad-hoc or dynamic manner, and these signals are received by the receivers positioned throughout the institution. As with IR/RF system, the receivers transmit the data from the NFC devices to a bridge for transmission to the institution's information engine.

NFC device preferably operates at a short range communication format of magnetic induction, 9 kHz, <125 kHz, 125 kHz RFID, 13.56 MHz, 433 MHz, 433 MHz RFID, and 900 MHz RFID, and preferably at a bit rate of less 256 kilobits per second or approximately 426 kilobits per second. The communication format is preferably IEEE Standard 802.15.4.

The NFC tag may include in some embodiments a microcontroller, a first transceiver for transmitting at the short range communication format, a second transceiver for transmitting at the medium range communication format, a memory, and a power supply. The transmissions are transmitted through the transceivers. The power supply provides power to the components of the NFC device. As with other tags, all of the components are preferably contained within a housing.

The NFC interface may have a range of approximately 2 to 4 cm. The close range communication with the NFC interface may take place via magnetic field induction, allowing the NFC interface to communicate with other NFC interfaces or to retrieve information from tags having radio frequency identification (RFID) circuitry. The NFC interface may provide a manner of initiating or facilitating a transfer of user data from one receiver to another receiver.

Implementation of NFC are known in the art. See, for example, Patent Application publication 20100082784 to Rosenblatt et al (Apple) published Apr. 1, 2010.

### 2.e Other Protocols

Similar to the descriptions above, other communication protocols are available. These include Wireless Fidelity (Wi-Fi) which follows IEEE 802.11b. Wi-Fi is capable of approximately 50 m range. Data rates vary, although 11 Mb/s is possible in theory, but 7 Mb/s is more realistic. Walls can reduces range and throughput. Number of users can reduce data rates. Wi-Fi has limitations in that Wi-Fi was not designed with robust security in mind. It is prone to interference problems, because Wi-Fi operates in unlicensed 2.4 GHz spectrum, where it competes with other products.

Another communication protocol is World Interoperability for Microwave Access (Wi-MAX) which follows IEEE 802.16. Wi-Max has the theoretical bandwidth up to 70 Mbps. Fixed (line-of-sight), and Fixed Wireless Mobile (non-line of Sight).

Another communication protocol is Bluetooth which follows IEEE 802.15.1 Bluetooth operates at short range—10 m, and was designed to eliminate short-range cables. Bluetooth has a data rate of about 1 Mb/s. It can be used to establish “as-needed” networks.

Another communication protocol is ZigBee, which follows IEEE 802.15.4 (WPAN). It is self-forming, self-healing mesh architecture. It is less expensive and simpler than Bluetooth, and has low power requirements. Its data rates are relatively low at rates of about 20-250 Kb/s. An embodiment of tag 12 using ZigBee may incorporate Texas Instrument CC2531 combined with Texas Instruments' ZigBee protocol stack (Z-Stack™). CC2531 is a USB enabled true system-on-chip (SoC) solution for IEEE 802.15.4, ZigBee and RF4CE applications. It enables USB upgradable network nodes to be built with in-system programmable flash memory, 8-KB RAM. The CC2531 may operate at ultralow power consumption which is useful in tags and other wireless nodes, if utilized.

Those skilled in the pertinent art will recognize that other communication formats may be used with departing from the scope and spirit of the present invention. The medium range communication format also allows the tags to communicate with the receivers to transmit interaction information.

### 2.f Phone Tags

The tag providing NFC connectivity in the context of the present invention need not be a separate device. NFC connectivity is currently provided as a function on certain smartphones, such as the Nokia C7, Google Nexus S and Samsung Galaxy S II. Alternately, NFC functionality may be added to phones or other such devices by, for example, including within the phone circuitry the PN65N chip from NXP. This chip is a combination of the PN544 NFC controller and an embedded SmartMX secure element. An application may be downloaded onto a phone or other device to provide various functionalities made possible by the NFC communication.

In one embodiment, the phone thus serves as the tag, communicating information to an NFC receiver by swiping the phone over the NFC receiver or bringing the phone in sufficiently close communication with the NFC receiver to permit the exchange of data.

### 2.g Global Positioning Systems

An alternative system is that involving the global positioning systems (GPS) is an outdoor satellite-based worldwide radio-navigation system formed by a constellation of satellites and ground control stations. The 3D position of the user is determined by the GPS receiver using triangulation from these satellites. GPS is an established location technology that offers a wide range of off-the-shelf solutions in both hardware and software. According to Caldas et al. [11], GPS applications have been applied to construction practices, such as positioning of equipment and surveying. However, when using only GPS, there is limited potential in other applications such as improving the management of materials on construction job sites, due to the limitations of this technology; it can only operate outdoors, and it needs to be attached to each entity that is being tracked. Since the number of materials involved in a project is usually significantly large, it is in most cases infeasible to attach a GPS receiver on each piece of the material.

### 3 Receivers

A signal from a tag 12 is received by receiver 20. FIG. 2 illustrates a specific embodiment of the receiver of FIG. 1. It should be appreciated that the specific embodiments of the receiver depicted in FIG. 2 is representative only and should not be understood as exclusive. The receiver may have an enclosure of plastic, metal, composite materials, or other suitable materials in any combination. The enclosure may protect the interior components of the device from physical damage and electromagnetic interference (EMI). Additionally, the enclosure may allow certain frequencies of electromagnetic radiation to pass through to wireless communication circuitry within the handheld device to facilitate wireless communication.

The receivers may be wall- or ceiling-mounted. In such installations, the location of the receivers is known. Receivers may also be located on movable objects, such as hygiene carts of the present invention. In such cases, the receivers must identify their location in the same manner as tags. In normal operations, such movable receivers are moved relatively rarely, and, thus, are movable, but not mobile.

Receiver 20 is operable to receive the identification and other communication signals transmitted by tag 12. Further, each receiver 29 is operable to forward the information received to the information engine 28, either directly or by way of a collector or bridge 30. In this manner, the location of, and other information about, each user wearing a tag, or an object bearing a tag, may be tracked as the users or objects move throughout the institution. Besides providing the information engine with identification information about the user, functions (e.g. deactivating a nurse call light) may be triggered upon reception of the identification signal by a receiver associated with the function (e.g. a receiver in the patient room associated with the nurse call light).

Where tag 12 emits an IR signal the receiver 20 may incorporate an infrared (IR) interface to enable the receiver to receive and/or transmit signals with infrared light. By way of example, the IR interface may comply with an infrared specification for data transmission published by the Infrared Data Association (IrDA). See http://www.irda.org/index.cfm (last accessed Oct. 12, 2011). Alternatively, the IR interface may function exclusively to receive data signals or to output data signals regarding an available resource. In this way, the receiver may issue signals to use a resource of other electronic devices that may lack other interfaces for communication.

Certain embodiments of the receiver 20 may also include a near field communication (NFC) interface, which, as described above, may allow for extremely close range communication at relatively low data rates. A near field communication (NFC) communication channel may be employed for data transfer between the resource-sharing device and the resource-using device. The NFC communication channel may arise if both the resource-using device and the resource-sharing device have NFC interfaces that are placed in close proximity, such as may occur when the devices are tapped together or brought close together. Thus the location of the NFC interface in the receiver must be accessible on exterior of the enclosure. The NFC interface may enable the receiver to engage in near field communication (NFC) with RFID tags or other NFC enabled electronic devices. For example, the NFC interface may provide a manner of receiving information indicating the location and/or identity from an NFC interface or an RFID tag located on the other device. It should be appreciated that the NFC communication channel may generally remain open for a relatively short period of time and may operate at a lower bandwidth. As such, the NFC communication channel may generally accommodate a relatively small amount of initial data transfer; a follow-up data transfer may generally take place via another of the communication channels.

In all events, the receiver 20 will have an interface that matches the protocol utilized by tag 12, and vice-versa.

The receivers of the present invention are preferably not identical. In the preferred embodiment, receivers 20 mounted on the ceiling or wall of the institution may operate using, for example, the IR/RF protocol. At the same time, receivers 20B located on hygiene station 102 in a fixed configuration may be wired and utilize RFID and NFC communication protocol, while receivers 20C located on movable hygiene cart 103 may utilize RFID and NFC communication protocol but utilize wireless communications. Similarly, Receiver 20 positioned in the ceiling or wall may not incorporate a camera or other visual device, but receivers 20B and 20C positioned to associate with hygiene stations 102, 103 may incorporate a camera or other device operable to recognize movement.

Certain embodiments of the receiver may include voice functionality. As such, the receiver may include audio input structures and an audio output structure. The audio input structures may be one or more microphones for receiving voice data from a user, and the audio output structure may be a speaker for outputting audio data, such as data received by the receiver over the network. In certain embodiments, an audio port may facilitate peripheral audio input and output devices, such as headsets, speakers, or microphones for use with the handheld device. It should be appreciated that the voice functionality associated with the receiver may also include emitting a ringtone through the audio output structure or otherwise to indicate incoming voice data.

### 4 Communication

The receiver may connect to the information engine 28, preferably by a network. The network may be a wired network or wireless.

The network topology can be of any physical or logical form. For example, in one embodiment, the invention may utilize the star network topology, whereby each receiver 20 is connected to a server 27 which is a central server with point-to-point connections, either direct or through other nodes, but where all of the nodes on the network are connected to a central hub. All communications travel via the central hub, and, thus, the star topology is easiest to design, implement, and expand, which requires only adding additional nodes. Its limitations are that the hub represents a single point of failure, and makes the hub an operating bottleneck. Another embodiment of the system 100 may utilize the ring network topology, which is well known in the art.

A “tree” or “root” network topology has a “root” node connected to one or more other nodes that are one level lower in the hierarchy similar to a tree limb. The tree topology is the basis of most enterprise and service provider backbone networks because it provides scalability and allows large numbers of devices to be connected together in a hierarchical topology. The nodes in a network may process data so that the nodes that are at higher levels in the hierarchy may perform more processing than the nodes that are lower in the hierarchy.

Another embodiment is mesh networking. The physical fully connected mesh topology is costly and complex for practical networks, but partial mesh networks where some of the nodes of the network are connected to more than one other node in the network with a point-to-point link provides most of the advantages decentralization, which avoids the single-point-failure disadvantage star and tree networks.

In case of a wired network, the receiver may comprise a wired I/O interface for wired interconnection between one receiver and one or more intermediate devices such as bridge 30, and/or directly with server 27 hosting information engine 28, or with another node. The wired I/O interface may represent, for example, a universal serial bus (USB) port or an IEEE 1394 or FireWire® port, but may also represent a proprietary connection. Additionally, the wired I/O interface may permit a connection to user input peripheral devices, such as a keyboard or a mouse. For example, the wired I/O interface may be a proprietary connection for interconnecting the device via standard jacks, USB or FireWire. Once connected, the devices may synchronize and/or transfer data.

The resource-using device and the resource-sharing device are preferably connected via a local area network (LAN) communication channel. The respective LAN interfaces of the resource-using device and the resource-sharing device may share a peer-to-peer connection directly to one another via the LAN communication channel, or may connect to one another via a router or a network controller along the LAN communication channel. The LAN communication channel may represent a wired connection, such as an Ethernet connection, but may also represent a wireless connection, such as an IEEE standard 802.11.x wireless network, or Wi-Fi. The wired I/O communication channel may generally permit an exceptionally rapid transfer of data between the resource-using device and the resource-sharing device 94. The network interface may also include a local area network (LAN) interface. The LAN interface may represent an interface to a wired Ethernet-based network, but may also represent an interface to a wireless LAN, such as an IEEE 802.11x wireless network. Additionally, in many cases, a connection between the receiver and another device or the information engine via the LAN interface may involve communication through a network router or other intermediary device.

One or more network interfaces may provide additional connectivity for the receiver. The network interfaces may represent, for example, one or more network interface cards (NIC) or a network controller. In certain embodiments, the network interface may include the capability of interfacing by way of a Bluetooth network, an IEEE 802.15.4 (e.g., ZigBee) network, or an ultra wideband network (UWB). The PAN interface may permit one receiver to connect to another local receiver via an ad-hoc or peer-to-peer connection. However, the connection is limited by the range of the protocol.

The receiver 20 and the information engine 28 may also be connected by way of the Internet. For the receiver, either directly or through an intermediary device, and the information engine to connect over the Internet, the resource-using device or the resource-sharing device may connect directly to the web service via the respective WAN interfaces of the devices, or may first query a web service to obtain an internet protocol (IP) address of the other. The web service may represent a dynamic domain name system (DNS) service, which may maintain the current IP address of each device by communicating with a plugin associated with the simplified data transfer application residing on each device. The devices may reach the Internet via its wide-area network (WAN) communication channel, which may represent, for example, a cellular data network such as EDGE, a 3G, 4G or LTE network. The wired I/O interface and the network interfaces may represent high-bandwidth communication channels for transferring user data using the simplified data transfer techniques.

The receiver 20 or an intermediary device such as bridge 30 may in some embodiments include a display which may include the user interface in the form of a GUI, which may also have a number of individual icons representing applications that may be activated. In some embodiments, the display may serve as a touch-sensitive input device and the icons may be selected by touch. In some embodiments, a resource-sharing application icon may be selectable by a user. When the resource-sharing application icon is selected, the resource-sharing application may open. The resource-sharing application may enable a user to use a resource of other electronic devices or applications. The user interface on the display may also include certain status indicator icons, which may indicate the status of various components of the device. For example, the status indicator icons may include a wired, wireless or cellular reception meter to indicate connectivity.

The receiver establishes communication channels over which communication between the receiver and the tags and information engine are established. It should be appreciated that the communication channels may be used for any data transfer that may take place between the two devices, and may include, for example, a transfer of resource-sharing information indicating how the resource-sharing device may share resources, a transfer of a resource-sharing software plug-in for using the resources of the resource-sharing device, or various intercommunication that may take place in a resource-sharing stream for using the resources of the resource-sharing device with the resource-using device.

In a first step, a user may launch resource-sharing software of both devices by abutting the NFC interfaces or by tapping the NFC interface of the tag to the NFC interface of the receiver, causing the two devices to establish the NFC communication channel. In the next step, resource-sharing information from the tag may be communicated to the resource-using receiver over the NFC communication channel. The resource-sharing information may provide information sufficient to enable the receiver to utilize the information embedded in the tag. By way of example, the tag information may include a serial number of the tag and/or an XML message having information identifying the tag and/or the user. The serial number may enable the receiver to communicate the information to the information engine to search a database, and, based on the serial number, the information engine may compile information identifying the tag, the location of the receiver, a identify of other users within the immediate area, such as patients, and the like. If the resource-sharing information includes an XML message, the XML message may provide similar or other information.

### 5 Multi-Modal

In the preferred embodiment, tags 12 and receivers 20, 20B and 20C are operable to communicate and process information using multiple protocols. For example, tags 12 and receivers 20, 20B and 20C may incorporate as microcontroller 40, 57, respectively, a chip that is operable to communicate and process information using multiple protocols. A chip which can be configured to be so operable is disclosed in, for example, United States Patent Application 20110111707 to Rofougaran (Broadcom Corporation), and published May 12, 2011. The “DETAILED DESCRIPTION OF THE INVENTION” of Application 20110111707 is here incorporated by reference for the description of multi-modal system.

Tags and receivers incorporate antenna diversity 43 and 54 to enable multiple communication protocols, which also improve the quality and reliability of a wireless link.

### 6 Information Processing

The information engine 28 preferably continuously receives transmissions from the network formed by the receivers via the bridges concerning the movement of users and/or objects bearing a tag within the institution.

The information engine may be the Versus Technology Versus Advantages™ RTLS program and software, or similar program and software known in the art that have the capability of creating and delivering accurate location data and intelligent, rules-based enforcement based on location and other data obtained from tags and other sources.

A system and method of at least one embodiment of the invention transmits signals, such as NFC, infrared and/or radio frequency signals from the tag to the appropriate NFC/IR/RF receivers. The method of at least one embodiment of the invention includes: (1) modulating a first carrier signal with a first packet including a first set of subject identification data having a first set length to obtain a first modulated signal; (2) transmitting the first modulated signal containing the first packet, transmission of the first modulated signal consuming a first amount of electrical energy, the first modulated signal having a first location precision and a first range within the tracking environment; (3) modulating a second carrier signal with a second packet including a second set of identification data reduced in length from the first set of identification data; and (4) transmitting the second modulated signal containing the second packet, transmission of the second modulated signal consuming a reduced amount of electrical energy.

The transmission of infrared and radio frequency signals may also be reversed and sent from an in-room emitting device to be received by a tag having receiving capability and affixed to a mobile subject, such as a user or object.

The first and second modulated signals are received by the receivers and relayed to other apparatus of the real-time tracking system which demodulates the signals to obtain the first and second packets.

A method and system of at least one embodiment of the invention continuously scans the transmissions returned to the locating system to recognize identical derivatives. The method includes the steps of, for each data packet, matching IDs and potentially requesting a new, incremented derivative length from all IDs found to be matching, repeating the process until the IDs no longer match or the review process times out.

Typically, the maximum effective line-of-sight range of such infrared signals is about a twenty meter diameter. To achieve a more precise location within the system, the infrared receiver may have its field of view reduced to as little as a one meter diameter by introducing a restrictor in the IR receiver. The tags may also transmit radio frequency (i.e., RF) signals which are received by an RF receiver. The RF signals emitted by the antennas are received by an antenna of a radio frequency receiver having a range of approximately forty meters in all directions. Typically, information is collected using in-ceiling and/or in-wall receivers connected by a serial network that terminates at the microprocessor-based collector.

The receiver, other than receivers associated with movable equipment such as hygiene carts, is stationary and its location is known. Tags are worn by mobile users and transmit unique IDs which allow the tracking system to associate unique subject identifiers (such as name, medical record number, tag type) to each individual tag. With this association, when IR signals are received by an IR receiver the tracking system identifies the tag(s) (and hence the users) as being in the location associated with the receiver. The tracking system aggregates the unique IDs received from the tags enabling the system to identify when one or more unique IDs are present at a particular location (represented by an IR receiver).

The information engine 28 processes the transmissions from the receivers and calculates a real-time position for each of the users and objects, and determines the proper behavioral norms for the specific user, objet and location or context. The signals appearing along the connection are received by a microprocessor-based collector, identifiable by a unique digit identifier. The collector can be configured to maintain an RF buffer of recent RF data packets and an IR buffer of recent IR data packets. Each time a new RF data packet or a new IR data packet is received, the microprocessor-based collector executes a match process and a buffer review process in an attempt to match transmissions that originated from the same tag. The match and buffer process is disclosed in United States Patent Application publication 20110121962 to Tenarvitz, Real-Time Method And System For Locating A Mobile Object Or Person In A Tracking Environment While Conserving Electrical Energy In A Battery-Operated Tracking Tag Associated With The Object Or Person; published May 26, 2011, the entirety of which is hereby incorporated by reference.

Additionally, the system of the invention may additionally utilize a context-aware system for facilitating the delivery of healthcare to patients within a clinical environment United States Patent Application publication 20110125524 to Tenarvitz et al., Context-Aware Method And System For Facilitating The Delivery Of Healthcare To Patients Within A Clinical Environment Monitored By Real-Time Locating Apparatus, published May 26, 2011, which is here incorporated by reference in its entirety. The described context-aware system monitors by real-time locating apparatus including auto-ID patient tags wherein patients having tags are located within the environment in real time by the apparatus, the system comprising: a plurality of self-service units wherein at least one of the units is configured to store a plurality of auto-ID patient tags and wherein the at least one of the units includes a dispensing mechanism to dispense stored tags; and a control computer subsystem coupled to the at least one of the units and including at least one user interface, a processor operable to execute software instructions, a memory operable to store software instructions accessible by the processor, and a set of software instructions stored in the memory to at least partially perform the steps of: identifying an incoming patient; assigning a stored auto-ID patient tag to the identified patient to obtain a tag assignment; transmitting a signal over a communication channel to an electronic medical record subsystem to link the tag assignment to a medical record of the patient whereby the patient becomes a linked patient; and controlling the dispensing mechanism to dispense a stored tag to the linked patient.

The tags worn by mobile objects may also incorporate one or more switches that when activated add an identifier to the data packet transmitted by the tag. Typical switch types include manual switches such as an externally accessible push button switch on the tag, a motion switch activated automatically by the tags subject's motion or an external switch. When activated, a switch may cause the tag to transmit the modified signal immediately or it may transmit the modified signal during the next periodic transmission, depending on the immediacy associated with that switch's function.

Similar to the above description of the IR/RF tags transmissions, an NFC signal is transmitted from one of the users to a receiver on the network utilizing a medium range communication format as discussed above. The signal contains information pertaining to the NFC interaction. The receiver transmits the signal through the mesh network to a bridge for further transmission to an information processing engine. Tags also permit valid interactions with other tags, especially using NFC tags and a short range communication format as discussed above.

When using NFC tags, preferably the distance to the receiver is short, and most preferably the tag and receiver are physically touching, or near physically touching. Requiring such proximity allows for power savings since the transmission field for each of the NFC devices is a minimal amount. If the NFC device were to transmit using a typical RFID signal or BLUETOOTH signal, then the power consumption would be greater.

### 7 Event Recognition

Detecting and reporting cleaning events (such as, e.g., hand washing events) at a hygiene station are described in a variety of documents, including, for example: U.S. Patent Application publication 20110121974 to Tenarvitz, published May 26, 2011; U.S. Patent Application publication 20110093313 to LeBlond, published Apr. 21, 2011; U.S. Patent Application publication 20110057799 to Taneff et al, published Mar. 10, 2011; U.S. Pat. No. 7,375,640 (Plost); U.S. Pat. No. 7,812,730 (Wildman); U.S. Pat. No. 7,242,307 (LeBlond et al.); U.S. Pat. No. 6,882,278 (Winings et al.); U.S. Pat. No. 6,727,818 (Wildman et al.); U.S. Pat. No. 6,426,701 (Levy); U.S. Pat. No. 6,392,546 (Smith); U.S. Pat. No. 5,952,924 (Evans et al.); U.S. Pat. No. 5,202,666 (Knippscheer). Other techniques and/or apparatus to provide cleaning events, detect cleaning events, and/or communicate data associated with cleaning events may be used, i.e., the provided examples are not intended to be exclusive of other approaches.

Events may also be tracked by 2D vision-based cameras, incorporated into receivers 20. The cameras in receivers 20 infer the users' or objects' motion in each video frame based on prior appearance and location history. The system, however, can be utilized to track multiple entities and activities even if the users or objects do not have tags. The camera system may also be designed to focus on particular locations and actions, such as hand hygiene compliance activities, where traditional sensors may be inadequate. However, the tracking capabilities are somewhat limited because of illumination differences and it is difficult to extract non-visual information. Location can be obtained by triangulation, matching points detected from two different views. Some known algorithms for location tracking are SIFT (Scale-Invariant Feature Transform) [D. G. Lowe, Distinctive Image Features From Scale-Invariant Keypoints, International Journal of Computer Vision; Vol. 60, No. 2; (2004), pp. 91-110] and SURF (Speeded Up Robust Features) [H. Bay, T. Tuytelaars, L. V. Gool, SURF: Speeded Up Robust Features, Computer Vision and Image Understanding; Vol. 110, No. 3; (2008), pp. 346-359]. A description of one attempt to use this system in a construction site environment is found in Brilakis et al, Automated Vision Tracking Of Project Related Entities, Advanced Engineering Informatics, October 2011, pp. 713-724 (October 2011).

In another embodiment, the compliance system 100 of the invention also utilizes a 3D range imaging camera, which is also called a Flash LADAR. In flash LADAR, the system flood-illuminates the scene with a single (or multiple) sub nanosecond laser flash(es), and can provide very short exposure 3D pictures of a target that may be changing its position or configuration rapidly. The technology, however, has a relatively very weak return signals at each pixel, because the illumination is distributed over an extended area covering many pixels. This limitation may be overcome by incorporating single-photon-sensitive focal planes, which are sensitive to single-photon LADAR returns and the timing information is digitized in the pixel, eliminating readout noise. Location of each pixel area in the scene is determined by time-of-flight algorithms. These must currently be calibrated for each camera model. A frame per second rate can be set high enough for tracking. One limitation of the system is that the cameras may interfere with each other when multiple cameras are used in proximity to each other.

### 8 Behavioral Recognition

In another embodiment, compliance with the required hygienic regime may be monitored by behavioral recognition technology. Behavioral analytic software provides automated awareness of behavior. Taking visual input from either a live camera or recorded video, the software autonomously recognizes activities and behaviors normally occurring in an environment or scene. When behavioral analytic software observes defined behavioral patterns, such as hand hygiene for an appropriate time period, the software generates an entry to the information engine. When behavioral analytic software observes defined anomalous behavioral patterns, such as failure to hand-wash for an appropriate period after a cleaning agent is dispensed, the software communicates a suitable entry to the information engine and/or issues an alert in real time. In practice, the system can be managed through a user-friendly desktop and browser-based application. Software is installed and linked to a camera feeds. After video analysis, the recognition system may further export the data to the information engine for analysis Software suitable in the practice of this invention is known in the art. Examples of such software include Cernium' s Perceptrak and Archerfish systems; AISight™ and Behavioral Analytics™ technology systems provided by Behavioral Recognition Systems, Inc.; CleverSys, Inc. has developed the PhenoScan, comprising multiple independent software programs for the recording and analysis of unique behavioral phenotypes through high-throughput, real-time video analysis of animal activity. Are described in U.S. Pat. No. 7,983,448 to da Vitoria Lobo et al. issued Jul. 19, 2011; United States Patent Application publication 20080031491 to Ma published Feb. 7, 2008; U.S. Pat. No. 7,565,295 to Hernandez-Rebollar issued Jul. 21, 2009; U.S. Pat. No. 7,426,301 to Porikli issued Sep. 16, 2008;

Upon installation, the software is trained to observe and identify compliant events and non-compliant events. The software uses the knowledge gained to distinguish compliant behavior from non-compliant behavior and then issues relevant reports and any necessary alerts. As the system continues to learn, more memories are created and refined, enhancing the compliance recognition capability.

### C. Hygienic System

One embodiment of the present invention relates to methods and systems for initiating a hand cleansing process based upon continual analysis of one or more compliance rules. The compliance rules form a hygiene regime designed to promote and measure, in real-time, users' hygiene performance. The regime may be implemented in any institutional environment, including health-care institutions. An embodiment is described below.

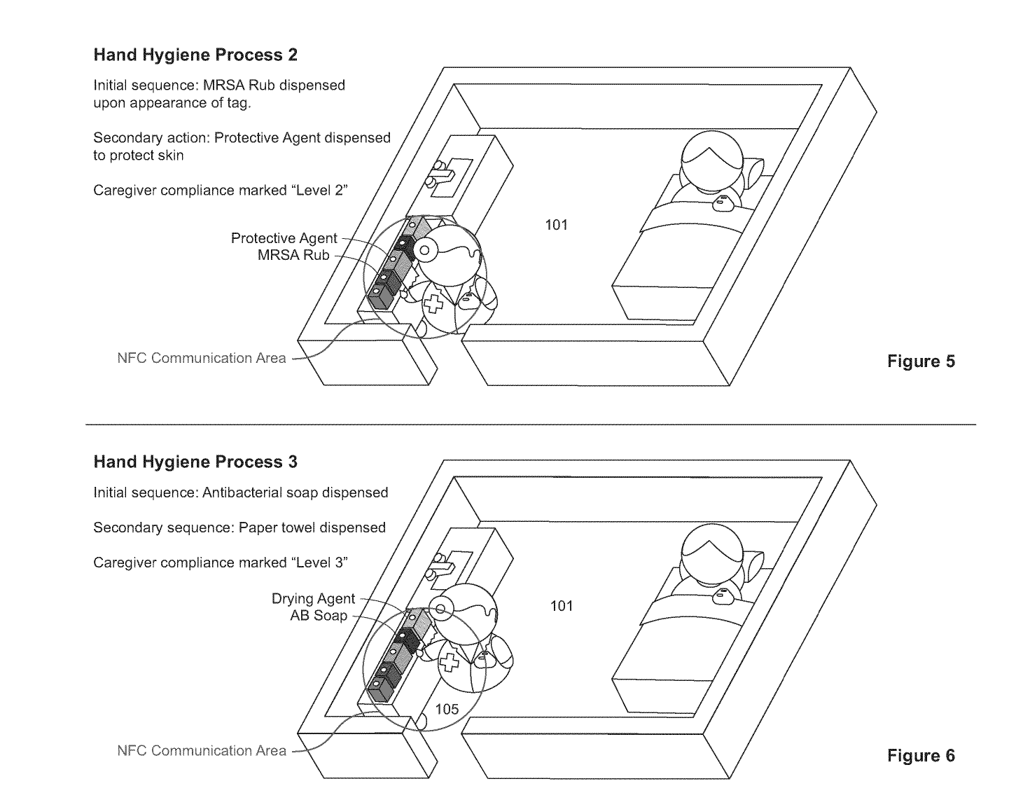

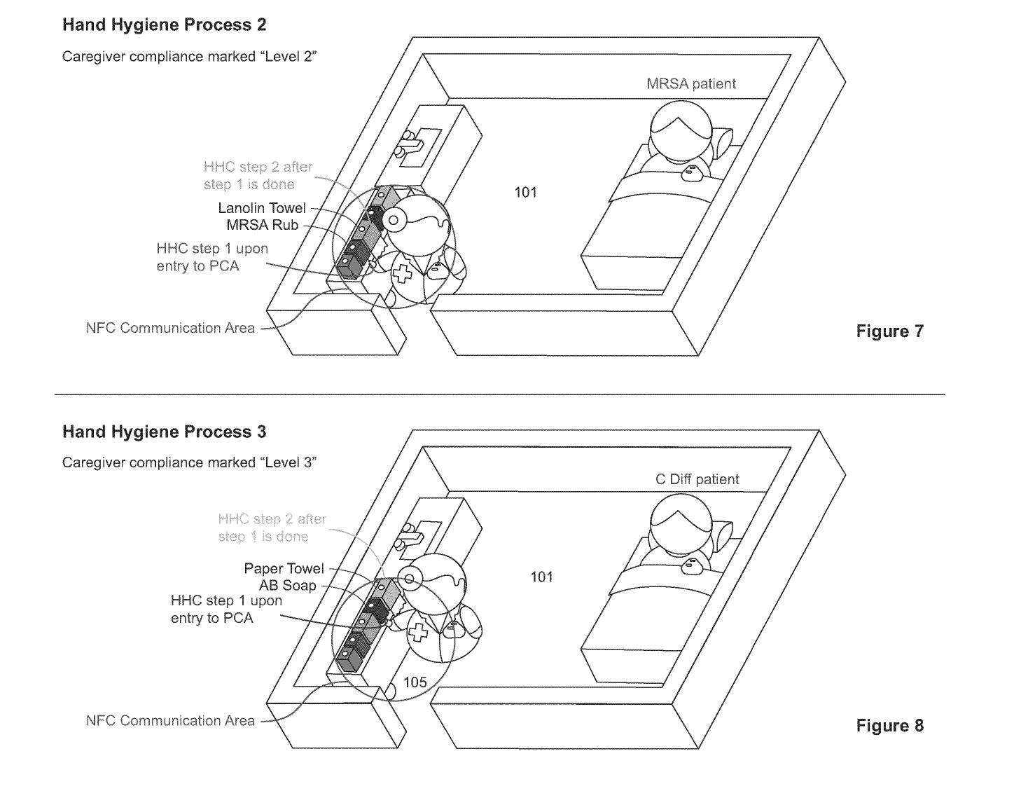

In a health-care embodiment, as shown in FIGS. 3-11, an institution includes patient care areas 101. The system as depicted in FIG. 3-11 include defined patient care areas 101, which may alternately be defined as the rooms in which the patient is located, or physical or virtual area surrounding a patient location. For example, the patient care area 101 may be designated as part of the room of the patient, an area within a certain radius of the patient's bed, or a radius around the location of the patient's tag. The patient area 101 is associated with a hygiene station 102.

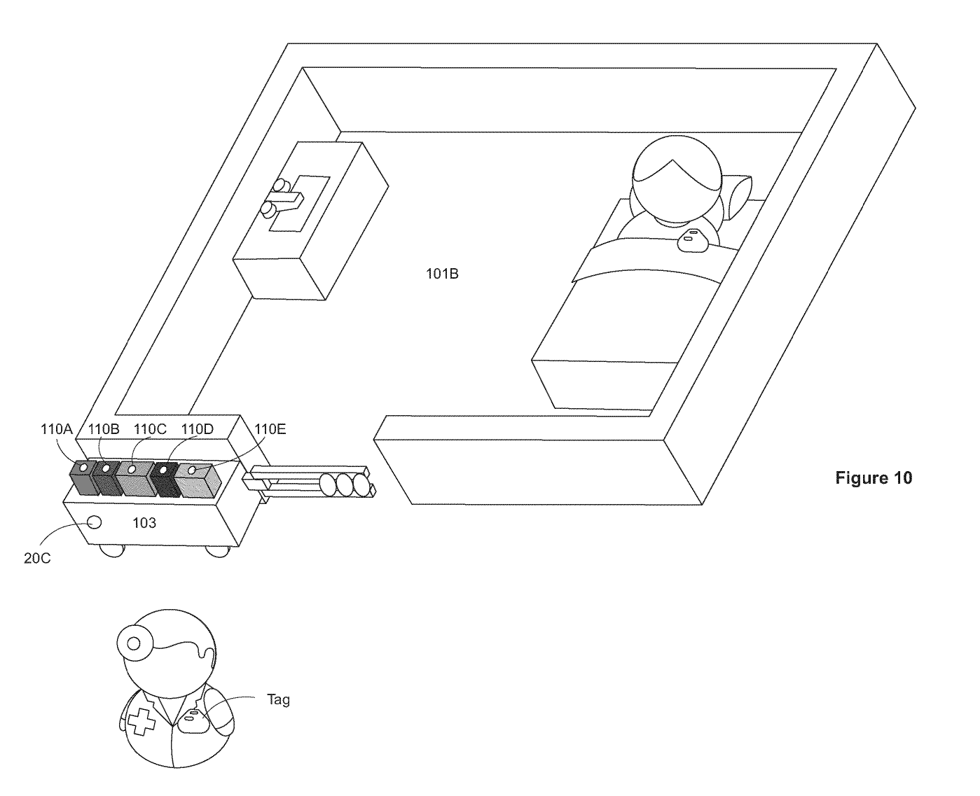

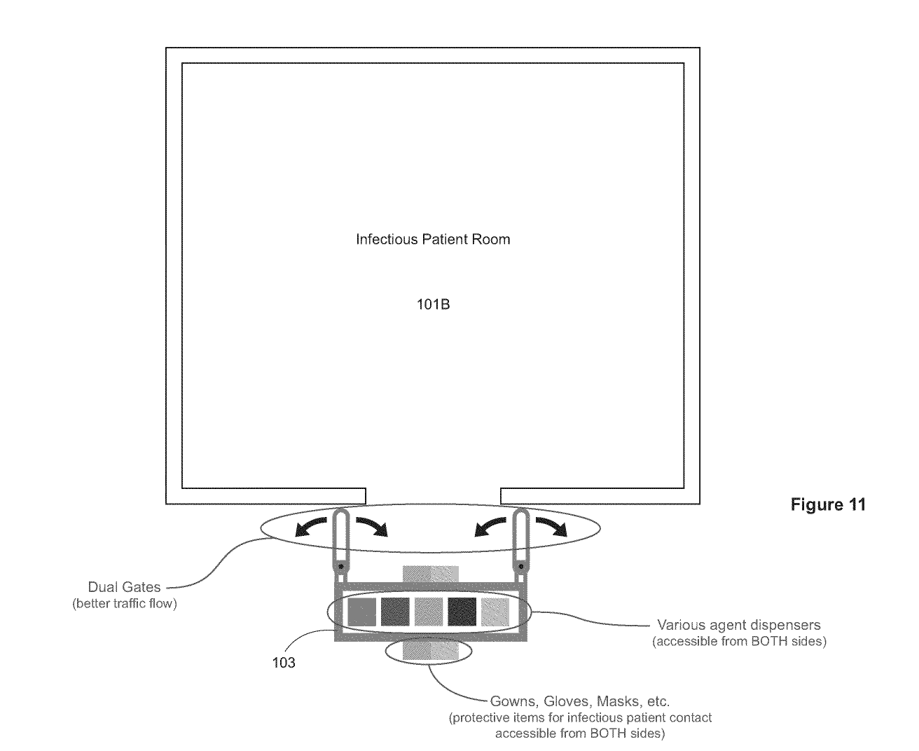

The hygiene station may be stationary or be in the form of a hygiene cart 103 as shown in FIGS. 10-11.

In the preferred embodiment a user will be presented with alternative cleaning agents. One cleaning agent may be especially stringent to provide the greatest possible efficacy, but may be damaging to the human skin, particularly if used over time. A second cleaning agent may be less stringent but also present the user with a lesser adverse impact. The user will also be presented with a protective agent and a drying agent. As a result, any given hand cleaning station may have multiple hand “cleaning-agent dispensers” (C-Dispenser), each with progressively more powerful cleaning agents. Depending on the specific agent being used, there may also be other associated “protective agent dispensers” (P-Dispenser) to condition hands as well as “drying agent dispensers” (D-Dispensers) to dry the hands.

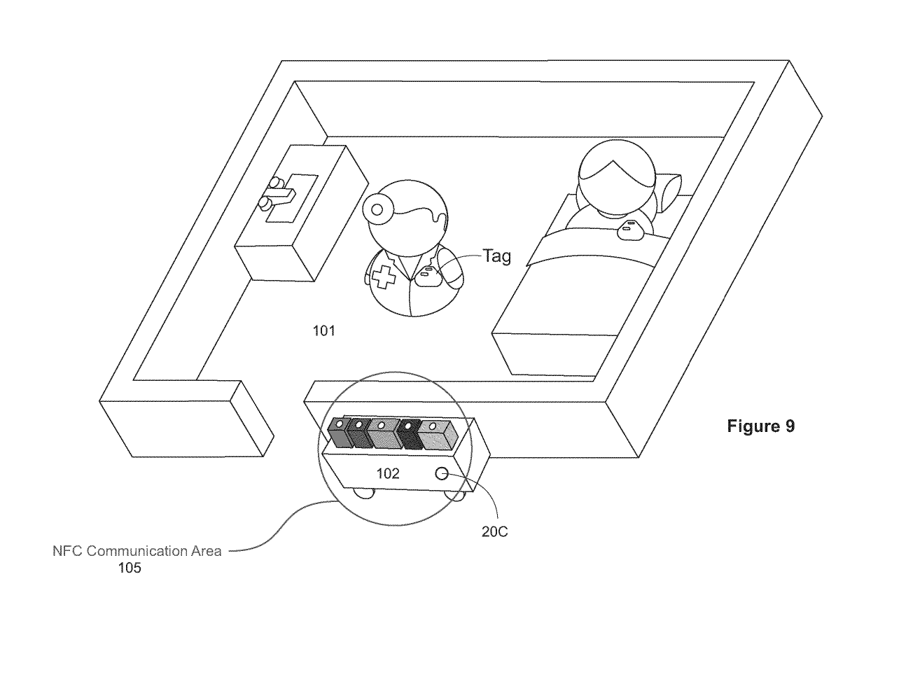

The hygiene station 102, 103 may be within the patient care areas 101 as shown in FIGS. 3-8, or be outside the patient care areas 101 as shown in FIGS. 9-11. Surrounding each hygiene station 102, 103 is a hygiene communication area 104. In one embodiment the hygiene communication area 104 is termed a near field communication area (NFC-Area) 105, because tags 12 and receivers 20 may operate within the area using NFC communication protocol and hardware. However, any communication protocol and hardware may be used within area 104, including the previously described communication protocols and hardware.

The hygiene regime may require certain hygiene practices associated with patient care area 101, which may be dependent on the movement of the user or object, prior history in the patient care area and/or on the medical history of the patient.

In one embodiment of the hygiene compliance system 100, a patient entering an institution is provided with tag 12. Tag 12 can utilize any of the communication protocols and hardware previously described. As shown in FIG. 2, tag 12 will preferably include a database 45 operably connected to the microprocessor-based microcontroller 40. Although shown in FIG. 2 as two separate components, it is immediately recognized that both components may be logical functions within a single microchip. Database 45 includes the identity of the patient and may also record the movements of the patient and items of the patients' medical history.

Each patient care area 101 is linked to at least one hygiene station 102. The system may include a single patient care area 101 linked to a single hygiene station 102, or multiple patient care areas 101 linked to one or more hygiene stations 102. As used here, a “link” between patient care areas 101 and a hygiene stations means that the two components are associated with each other in the system. The link may be embodied in linking data contained in one or both of a linked pair of a patient care area 101 and a hygiene station 102. If the linking data is stored on the information engine 28, for example, it will typically identify the linked hygiene station(s). Linking data may also be stored on other components in the system.

Information engine 28 tracks the movement of a user into patient care areas 101. The tracking may be by way of location data communicated by tag 12 to receiver 20. Tracking is enhances if portals for entry into and for exit from patient care areas 101 include a receiver 20 sufficient to recognize the entry and exit of a user into and from patient care areas 101 or other designated areas. The recognition of entry into and/or exit from patient care areas 101 may additionally comprise the activation of a time window within which defined hygienic steps are required to be followed. The hygiene compliance system may also provide for issuing real-time feedback to correct or reinforce the hygienic compliance regime upon each user entering and leaving patient care areas 101 or other designated areas.

Hygiene station 102 contains dispensers to dispense hygiene-compliance-related materials. These include dispensers to dispense cleaning agents, antiseptic agents, protective agents and/or drying agents based upon the established hand hygiene rules. The rules may comprise a single standard operating procedure for the institution, or modified or distinct operating procedures based on any factors, including the specific location within the institution and the/or the medical history of the patient. The hygiene regime may also include comprise rules dependent on the prior movements of the user, or the more recent and/or anticipated movement into or out of patient care areas 101 by the user.

In one embodiment, the hygiene station 102 automatically dispense specific cleaning, antiseptic, protective and/or drying agents to be dispensed, and to automatically activate and/or signal the user to initiate the proper hand hygiene or other process required by the hygienic regime.

### 1) Hygienic Agents

Hygiene station 102 may comprise a selection of hygienic-related elements, which may be selected and configured in accordance with the hygienic regime of the institution. The hygienic agents within hygienic station 102 include hand hygiene materials and protective garments. The hand hygiene materials may comprise a water-based “cleaning agent,” waterless “antiseptic agent,” “protective agent” (which may be incorporated with the antiseptic agent), and/or “drying agent,” as those terms were previously defined. Protective garments encompass disposable and re-usable surgical gowns, surgical drapes, surgical face masks, surgical scrubs, footwear and gloves.

The system 100 is designed to encourage user adherences to the hygienic regime established by the institution. The hand hygiene system may require that users wear gloves, and such gloves are commonplace. However, gloves are an inadequate barrier to contamination that occurs during patient care. The CDC recommends that hand hygiene should be performed after glove removal.

In one embodiment, the hygiene station 102, 103 includes water, soap and basin for hand-washing. In the preferred system, the institutional hygienic rules require washing hands with soap and water when hands are visibly soiled, but not otherwise. The rule is justified in that frequent and prolonged hand washing attacks and destroys the protective function of the stratum corneum or the surface layer of the skin—which causes natural skin lipids to be dissolved and washed off the skin. This has been proven to lead to skin irritations and contact dermatitis in some instances because these natural oils and lips, which our naturally resident in our skin and which perform a protective function, help keep the skin in a good condition. In a distressed state, the skin develops fissures and cracks, which can be found by pathogens and microorganism and which cannot be reached by many antiseptics.

Nevertheless, it should be cautioned that in certain situations the use of washing hands with soap and water is called for even when hands are not soiled. For example, available antiseptic formulations that can be conveniently incorporated into the hand hygiene regime have generally poor sporicidal activity. Thus, if Clostridium difficile or other spores are present, it is the recommendation of the CDC that users wash hands with soap and water as the physical action of rubbing the hands and creating mechanical friction using soap and water helps to wash the bacteria down the drain even though it does not actually kill the spore. In a preferred embodiment, hygiene cart 102 comprises dispensers to dispense water and a soap that that contains antimicrobial or antiseptic agents.

Thus, in the embodiment, the hygiene station 102, 103 includes water, soap and basin for hand-washing, but does not require such hand washing. The institutional hygienic rules do require hand antisepsis. To support such action, hygiene cart 102 comprises dispensers to dispense a waterless antiseptic product that is not rinsed from the hands, and information engine 28 includes rules to activate a requirement to perform hand antisepsis.

The dispensers of hygiene cart 102 will preferably contain one or more of several waterless antiseptic compounds. The waterless antiseptic compounds are preferred to water-based cleaning, because such compounds may be formulated to be less irritating to skin than traditional hand washing with soap and water, to be microbiologically more effective, and require less time cleaning time. Hand hygiene performance with a waterless antiseptic-based hand rub typically requires one-third the length of time of a hand wash procedure.

### Antiseptic Cleaning Agent

The hygiene cart may include waterless alcohol compounds. Alcohols are preferred antiseptic agents because they have wide antimicrobial spectra and are fast acting, with antimicrobial activity of alcohols is attributed to the denaturation of proteins. Alcohol-based hand rubs work by killing the organisms on the skin rather than physically removing them.

Ethanol (ethyl alcohol) and isopropanol (isopropyl alcohol) both have in vitro activity against bacteria, fungi and viruses. Isopropanol has slightly greater activity than ethanol against bacteria. N-propanol appears to have the greatest in vitro activity against bacteria. In general, ethanol has greater activity against viruses than isopropanol. Alcohols are less active against nonenveloped viruses, such as hepatitis A virus, rotavirus, enteroviruses, and adenovirus. However, alcohols have been shown in in vivo studies to significantly reduce the titer of such viruses recovered from artificially-contaminated fingers. Although activity varies by compound and concentration, alcohols are active against gram-positive cocci, gram-negative bacilli, Mycobacterium tuberculosis, many fungi, and viruses, the effectiveness of which depends in large part on the length of application. Alcohol rubs of 60% are effective, but greater bactericidal effect has been found with higher concentrations. The higher alcohol content materials are more effective to a point, but tend to increase adverse consequences to the users' skin. A critical limitation of alcohol formulations is that alcohol does not show prolonged activity because alcohol rapidly evaporates. Further, 70% alcohol is a more effective antiseptic than 99% alcohol, because in the absence of water, proteins are not readily denatured by alcohol. A 99% alcohol solution coming into contact with a microorganism is reported to create a hardened protein wall around the outside of the organism, rather than permeating into its interior. Therefore, a 70% alcohol solution may be more effective than the pure (99%) product.

Another antiseptic cleaning agent is Chlorhexidine. Chlorhexidine is a cationic bisguanide that has both bactericidal and bacteriostatic mechanisms of action and derives its antimicrobial action by disrupting cytoplasmic membranes and precipitating cell contents. It is an effective and versatile antiseptic for both infection control and prevention. Chlorhexidine is consistently superior to povidone-iodine and a number of other antiseptics in reducing colonizing flora immediately and several days after application. Chlorhexidine is considered to have good activity against gram-positive cocci and somewhat less activity against gram-negative bacilli, fungi, and viruses. Chlorhexidine has minimal antimycobacterial activity and is not active against spore-forming bacteria. A distinguishing feature of chlorhexidine is its persistence, remaining active for hours after application. This persistence makes chlorhexidine a good candidate for surgical hand antisepsis, although it has a lower kill rates than alcohol.

Other examples of antiseptics include polyhexamethylene biguanide (PHMB) and polyhexamethylene guanide (PHMG), which are broad-spectrum antibacterial agents and have activity against human immunodeficiency virus type 1, and may be useful in certain applications. The substances are highly appropriate for use in critically colonized or infected acute and chronic wounds, in view of its broad antimicrobial spectrum and good cell and tissue compatibility. Furthermore, there has been no conclusive evidence to date of any pathogens developing resistances under the use of polihexanide. However, the compounds have a slow onset of action and a minimum exposure time of 10-15 minutes may be required. Others are quaternary ammonium compounds (e.g. benzalkonium chloride), phenol derivatives (e.g. ortho-phenylphenol) or carboxylic acids. U.S. Pat. No. 4,420,484 and DE 27 08 331 A1 describe antimicrobial skin-cleansing compositions which comprise octenidine dihydrochloride and optionally amine oxide. DE 102 05 883 and DE 196 47 692 discloses aqueous antiseptic based on bispyridiniumalkanes and comprising octenidine dihydrochloride, a nonionic surfactant, both stating that amine oxides is disadvantageous.

More recent biocides comprise polymerizable quaternary ammoniums, described in, inter alia, Parra-Ruiz et al, Polymeric Systems Containing Dual Biologically Active Ions, European Journal of Medicinal Chemistry, October 2011, pp. 4980-4991; Caillier et al, Synthesis And Antimicrobial Properties Of Polymerizable Quaternary Ammoniums, European Journal of Medicinal Chemistry, August 2009, pp. 3201-3208.

One embodiment of the hygiene cart includes a dispenser dispensing a stringent biocide sufficient to control methicillin-resistant S. aureus (MRSA). To reduce the impact of stringent biocides, the MRSA compound may be based on the antimicrobial activity and therapeutic efficacy of oleic acid (OA) in a liposomal formulations, which are described in, and have been reported to be bactericides against MRSA, in Huang et al, Eradication Of Drug Resistant Staphylococcus Aureus By Liposomal Oleic Acids, Biomaterials, January 2011, pp. 214-221. It is reported that in vitro studies showed that these OA-loaded liposomes (LipoOA) could rapidly fuse into the bacterial membranes, thereby significantly improving the potency of OA to kill MRSA compared with the use of free OA. Further in vivo tests demonstrated that LipoOA were highly effective in curing skin infections caused by MRSA bacteria and preserving the integrity of the infected skin using a mouse skin model. Moreover, a preliminary skin toxicity study proved high biocompatibility of LipoOA to normal skin tissues. These findings suggest that LipoOA hold great potential to become a new, effective, and safe antimicrobial agent for the treatment of MRSA infections, that may be used in a topical application.

Due to the cytotoxic effect of some antiseptics on human skin cells, the cytotoxicity and antiseptic properties must always be balanced.

### Formulations

Antiseptic cleaning are preferably incorporated into formulations. The particular selection of a formulation is a balancing. For example, rinses with low viscosity tend to dry most quickly. Gels, lotions and foams usually require more time to dry, depending on the formulation. Users may prefer products that dry quickly, while others may prefer products that take longer to dry but provide the benefits of a gel, lotion or foam. Further, users may view the emollient-rich gel, lotion or foam as leaving hands feeling smooth after use, but other users may view the products as “sticky.”

Critical factors are that alcohols are most effective antiseptics, but lack persistent activity, while chlorhexidines are less effective, but are persistent. Thus, one preferred formulation includes the combination of alcohol and chlorhexidine.

The preferred embodiments of the antiseptic hand formulations will include emollients to protect the skin. The emollients may be, for example, various combinations of polyethylene glycol, aloe, fatty acids and other known ingredients. Fragrances may also be added, such as, for example, D-limonene to add a lemon-orange fragrance to the formulation. Most preferred are formulations comprising the protective agents that are described below under the heading “protective agents.” The protective agents may be provided separately or be incorporated into formulations comprising the antiseptic cleaning agents. In all cases, however, it is necessary, however, that the emollient additives not interact with or diminish the effectiveness of the active ingredients. In particular, chlorhexidine may be inactivated by soaps and anionic agents. Therefore, it is important that any formulation that includes chlorhexidine be free of soaps and anionic agents.

The antiseptic cleaning agents may be presented as rinses, foams, gels, lotions or in other forms. Rinses have a consistency similar to water and usually dry more quickly than gels or foams. Rinses, however, may be more likely to drip from the hands onto to the floor during use, creating spots on the floor under dispensers. Most importantly, rinses do not provide the benefits of protective agents. Foams are less likely to drip from the hands onto the floor during application, but may produce greater sensation of “build-up.” Gels have a thicker consistency than rinses and are less likely than rinses to drip from the hands onto the floor, but, as noted, may produce a feeling of emollient slipperiness or “build-up” with repeated use.

Thus, in some embodiments, the composition of the antiseptic cleaning agents may include one or more surfactants. The surfactant can be a non-ionic surfactant, an anionic surfactant, a cationic surfactant, or a combination of surfactants may be used, recognizing, however, the limitation that soaps and anionics in particular may have adverse effect on Chlorhexidine if it is an active ingredient in the formulation. Exemplary surfactants include, but are not limited to, nonylphenol ethoxylates, alcohol ethoxylates, alcohol alkylates, sorbitan ester ethoxylates, ethoxylated alkyl-polyglucosides, alkyl ether carboxylates, fatty alcohols, ceteth-20, Octyldodeceth-20, Oleth-35, Oleth-25, Glycereth-18, Polysorbate 20, PEG-200 Castor Oil, PEG-80 glyceryl cocoate (Hetoxide GC-80), sodium lauryl sulfate, ammonium lauryl sulfate, and ethylene oxide-propylene oxide copolymers. Other surfactants known to those of skill in the art may also be used. In one embodiment, the surfactant is a non-ionic surfactant. The formulation may include a foaming agent such as dimethicone surfactant. The formulation quickly converts to a liquid when rubbed into hands and spreads for even coverage, and still dries fast.

The formulation may include thickeners, viscosity modifying agents and/or gelling agents may be added to the composition. Exemplary thickening agents include, but are not limited to, such as acrylic acid polymers, such as those, for example, available commercially under the trade name Carbopol (B.F. Goodrich) or modified celluloses, for example, hydroxyethylcellulose available commercially under the trade name Natrosol (Hercules) or hydroxypropylmethyl cellulose, amine oxides, block polymers of ethylene oxide and propylene oxide (for example, those available from BASF Wyandotte under the trade name Pluronic®, or a decadiene crosspolymer (available under the trade name Stabilez 60), ethoxylated fatty alcohols, salt (NaCl), phthalic acid amide, polyvinyl alcohols, fatty alcohols and alkyl galactomannans available under the trade name N-Hance from Hercules, in a suitable amount. Other thickening agents known to those of skill in the art may also be used. In some instances emulsifying waxes may be used to thicken the composition without the need for additional thickening agents.

Examples include (each may include colorants and perfumes if desired):

a) ethyl alcohol plus isopropyl alcohol, glycerin, carbomer 934, 2-amino-2-methyl-1-propanol, propylene glycol, isopropyl myristate, .alpha.-tocopherol acetate, d-.

b) Formulation of 1% w/w chlorhexidine gluconate and 61% w/w ethanol, preferably in an emollient-rich lotion base.

c) Formulation of 0.3 w/v Chlorhexidine Gluconate solution IP, 0.6 w/v Cetrimide IP, and Tartazine: this formulation has broad spectrum; virucidal, bactericidal and fungicidal activity even in presence of organic matter.

d) Formulation of 2.5% w/v Chlorhexidine gluconate solution IP and 63% v/v Isopropyl alcohol (2-Propanol) IP, preferably in an emollient-rich lotion base.

### Nasal Passages

In one alternative embodiment, the hygienic cart includes also a nasal compound and the hygiene regime includes use of nasal antisepsis to reduce nasal-borne infectious carriage. For example, nasal colonization of S aureus predisposes the carrier to S aureus infections. In one embodiment, the institution includes nasal dispensers comprising Mupirocin. Mupirocin is an antibiotic, effective against bacteria, including a host of antibiotic-resistant strains, and is persistent. Mupirocin blocks the activity of an enzyme called isoleucyl-tRNA synthetase within the bacteria. This enzyme is necessary in order for the bacteria to make proteins. Mupirocin is not effective against fungal or viral infections. Used intranasally, Mupirocin eliminates methicillin-resistant Staphylococcus aureus (MRSA). It appears most helpful among surgical and dialysis populations. In the preferred form, Mupirocin is presented as 2% calcium salt in a paraffin based ointment containing a mixture of fatty acids.

### Protective Agents

Some embodiments comprise protective agents. The protective agents may be incorporated in a formulation with the antiseptic or other cleaning agents, be provided as a discrete element or be incorporated into the drying agents. If provided as a separate discrete agent, the protective agent may be in the form of a lotion, cream, gel and/or ointment, depending on the desired viscosity.

Skin conditioning agents include, for example, moisturizers and barriers. Moisturizers or humectants are additives that attract moisture to the outer layers of skin to keep it moist and supple. Barriers prevent moisture already present in the skin from being lost. Exemplary skin conditioning agents include, but are not limited to, glycerol, propylene glycol, sorbitol, aloe vera, lanolin or lanolin-derivatives, petrolatum, sqaulene, cetostearyl alcohol, beeswax, tricaprylin, glyceryl cocoate, isopropyl myristate, isopropyl palmitate, cetyl alcohol, stearyl alcohol, mineral oil, shea butter, safflower oil, and other moisturizers and barriers known to those of skill in the art. Other skin conditioning agents such as vitamins, anti-oxidants and other skin health compounds can also be included in the composition. Additionally, skin treatment and or anti-irritant compounds, including allantoin, trioctanoin, niacinamide, methyl sulphone, and lactose can also be included in the formulations. The protective agents may also comprise emollients such as isopropyl myristate or triglycerides of fatty acids, for example, lauric triglyceride or capric/caprylic triglyceride, such as the triglyceride available commercially under the trade name Miglyol 810 (Huls UK); moisturizers such as D-panthenol; humectants such as glycerin or 1,3-butylene glycol; antioxidants such as DL-.alpha.-tocopheryl acetate or butylated hydroxytoluene. Humectants such as glycerin may be added for liquid rubs.

In some embodiments, protective agents comprise one or more phenolic compounds or phenolics, or polyphenols derived from the plant kingdom. Phenolic compounds are characterized by an aromatic ring bearing one or more hydroxyl substituents, and are identified by the number of carbon atoms of the basic skeleton. The simplest natural phenolic structures are the phenolic acids, such as hydroxybenzoic (C6-C1) and hydroxycinnamic (C6-C3) acids, and the more complex polyphenols generally build on these structures, which include tannins and flavonoids (flavonols, flavones, flavanols, isoflavones, antocyanidins and others). Phenolic compounds act as antioxidants with mechanisms involving both free radical scavenging and metal chelation. Polyphenols also exhibit antiviral, antibacterial, glucose regulating, immune-stimulating, antiallergic, antihypertensive, antiischemic, antiarrhytmic, antithrombotic, hypocholesterolemic, antilipoperoxidant, hepatoprotective, anti-inflammatory, anticarcinogenic antimutagenic, antineoplastic, anti-thrombotic, and vasodilatory actions. Phenolics exhibit low aqueous solubility, which renders formulations more difficult, but potentially enhances persistency on the skin. Some new water soluble polyphenol derivatives have been reported. WO 2010072754; PCT patent application PCT/EP07/055815; and Moon et al (2007, Appl Microbiol Biotechnol., Enzymatic Synthesis And Characterization Of Arbutin Glucosides Using Glucansucrase From Leuconostoc Mesenteroides B-1299CB.

Protective agent may be in liquid for, dry form or be incorporated into a cloth or paper towel, such as material impregnated with one or more of the ingredients associated with the protective agent, such as aloe vera and lanolin emollient formulations. In some embodiments, the Protective agent and the Drying agent may be the same, when, for example, an impregnated towel both protects the skin and dries the skin at the same time.

### Drying Agent

In some embodiments, the drying agent is unnecessary. In some embodiments, a drying agent may be preferred to complete the cleaning or protective step. One example of a drying agent is a high strength non-woven cloth material, non-hypoallergenic and latex-free. The material may be impregnated with one or more of the ingredients associated with the protective agent, such as aloe vera and lanolin emollient formulations.

### 2) Hygiene Station

The hygiene station 102, 103 according to the present invention includes a plurality of designated compartments, to provide the necessary hand hygiene materials and protective garments where such materials are required.

In the preferred embodiment, the hygienic system comprises a dispenser that controls the amount of cleaning agent, protective agent and/or drying agent that is dispensed to the user. Surveillance sensors or hygiene event sensors are disposed for detecting users' utilization of the hygienic station. The proximity sensors may be receivers of the present invention. Alternately or additionally, the proximity sensors may include a magnetic sensor that estimates the distance between the device and a tap or a cleaning agent dispenser, such as a cleaning dispenser. Optionally, the proximity sensor in the receiver 20 has the capability of sensing the quality of the personal hygiene event, such as previously described.

A number of automatic touch-free cleaning agent, towel and other dispensers are already on the market, which can be incorporated into with the requisite controllers for use with the invention. These include the line of automatic dispensing systems marketed by Georgia-Pacific under the enMotion® and goRag® marks, and the automatic dispensers marketed by Air Delights, Inc.

Optionally, an indicator is connected to each dispenser. In such a manner the indicators transmit an indication to the information engine 28 that logs a respective personal hygiene event accordingly. The quality of the events which are detected by the hygiene event sensors may be based on a cumulative value that is calculated by combining data from some or all of a plurality of hygiene event sensors. For example, a sum, a mean, and/or an average of the qualities which has been given to a certain hygiene event by a plurality of hygiene event sensors may be used for determining the quality of an event.

In one embodiment, the information engine logs the identified hygiene events. Each hygiene event is preferably tagged with a time stamp that reflects the time, or the approximate time, in which the relevant hygiene event has been identified. The time stamp may be based on the clock of the processor and/or on an external clock, such as a real time clock.

In another embodiment, the microcontroller logs the identified hygiene events in memory of the controller 57 of receiver 20, which may later be communicated to the information engine 28.

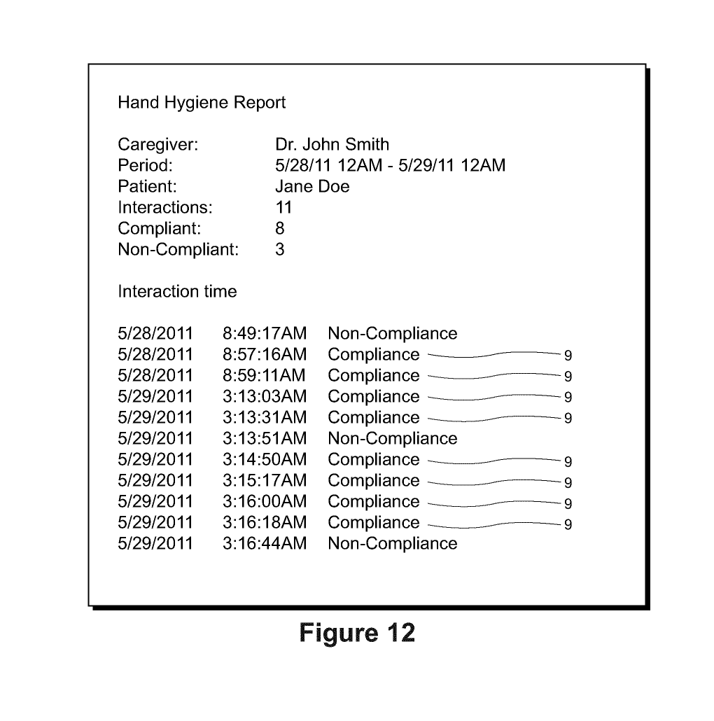

In use, the location detecting module may log information about the location of the user, optionally with association to a respective time stamp, which is optionally taken from the information engine. For example, FIG. 12 depicts an exemplary dataset of logged personal hygiene events. Each personal hygiene event is time and location tagged. Optionally, the quality of the personal hygiene event is documented when available.

According to some embodiments of the present invention, the dispenser controls the amount of material discharged. In another embodiment, the dispenser indicator includes a quantity sensor. In such an embodiment, the indicator may be used for verifying that the amount of cleaning agent which is released in a personal hygiene event, such as hand antisepsis, is sufficient for increasing the hygiene level of the user. Optionally, the quantity sensor includes a scale for measuring the weight of the hygienic agent in the dispenser. Optionally, the indicator includes a camera or other optical sensor for estimating a change in the amount of the cleaning agent. It should be noted that any sensor which may be used for detecting an amount change may be used as a quantity sensor. In such a manner, the indication of a dispensing of a sufficient amount of cleaning agent is considered as a personal hygiene event and is communicated to the information engine. On the other hand, a change, which is indicative of an insufficient amount of cleaning agent, is considered as a failure to perform a personal hygiene event.

The system also includes receiver 20 and a microcontroller 57 to track proper hand hygiene at a hospital by detecting that a user has utilized the cleaning agent, protective agent and/or drying agent. The microcontroller 57 preferably comprises a processor (CPU) and memory. The CPU may represent one or more microprocessors, and the microprocessors may be “general purpose” microprocessors, a combination of general and special purpose microprocessors, or ASICS. Additionally or alternatively, the CPU may include one or more reduced instruction set (RISC) processors or related chip sets. The CPU may provide processing capability to execute an operating system, run various applications, and/or provide processing for one or more of the techniques described here. Applications that may run on the microcontroller may include, for example, software for managing and performing content, software for using the resources of other chips or electronic devices.

The microcontroller 57 is preferably networked by an interface, such as Ethernet, or wireless protocols such as IEEE 802.11a/b/g/n or Wi-Fi. A main memory may be communicably coupled to the CPU, which may store data and executable code. The main memory may represent volatile memory such as RAM, but may also include nonvolatile memory, such as read-only memory (ROM) or Flash memory. In buffering or caching data related to operations of the CPU, the main memory may store data associated with applications running on the electronic device. The microcontroller 57 may also include nonvolatile storage. The nonvolatile storage may represent any suitable nonvolatile storage medium, such as a hard disk drive or nonvolatile memory, such as Flash memory. Being well-suited to long-term storage, the nonvolatile storage may store data files, software (e.g., for implementing functions on the microcontroller), monitoring information (e.g., information obtained by monitoring equipment), transaction information (e.g., information such as location or encounter information), wireless connection information (e.g., information that may enable the device to establish a wired or wireless connection), and security information. It should be appreciated that data associated with sharing resources with certain other electronic devices, such as resource-sharing software plug-ins, may be saved in the nonvolatile storage.

The hygiene station may provide for user input and/or output. The hygiene station may be remotely managed utilizing standard protocols, or, alternatively, the station may incorporate an interface for communicating with the microcontroller. If an interface is used, a display screen is provided, which may be any suitable display, such as liquid crystal display (LCD), a light emitting diode (LED) based display, an organic light emitting diode (OLED) based display, a cathode ray tube (CRT) display, or an analog or digital television. In some embodiments, the display may function as a touch screen through which a user may interact with the device. The microcontroller may further include a user interface. The user interface may represent indicator lights and user input structures, but may also include a graphical user interface (GUI) on the display. In practice, the user interface may operate via the CPU, using memory from the main memory and long-term storage in the nonvolatile storage. In an embodiment lacking the display, indicator lights, sound devices, buttons, and other various input/output (I/O) devices may allow a user to interface with the microcontroller. In an embodiment having a GUI, the user interface may provide interaction with interface elements on the display via certain user input structures, user input peripherals such as a keyboard or mouse, or a touch sensitive implementation of the display.

The receiver 20 and microcontroller 57 can further communicate to the information agent whether a set time passed between the dispensing of the cleaning agent and the release of the protective agent and/or the drying agent, to confirm that scrub time was maintained for the particular environment. Hand hygiene materials are stored in dispensers mounted on the cart, with the dispensers communicating with a microcontroller and/or receiver to permit communication with the information engine. Receivers are disposed to permit the practice of the invention.

The hygiene station may also similarly include protective garments such as surgical gowns, surgical face masks, footwear and gloves. In the same manner as establishing the cleaning practices, the system can determine whether the user had utilized appropriate protective clothing. For example, the protective clothing may be in a sealed sterilized pouch. The system can determine whether user had opened a compartment holding the pouch. Alternately, the pouch may include a RFID tracking tags. These are typically paper-thin reprogrammable laminate constructions about 50 mm×50 mm in size, comprising an antenna and a microchip. Their typical operating frequency is 13.56 MHz and they are passively powered from a RF interrogation field. The tags can be inventoried and tracked using standard RF systems. NFC devices share the basic technology with proximity (13.56 MHz) as RFID tags (as well as contactless smartcards). The transfer or movement of the pouch out of the hygiene station can be tracked by the receiver. The identification tags are described as RFID; however, it should be understood that, while RFID tags are preferred from a current practical and cost effective standpoint, it is anticipated that advances in technology will allow the use of other types of identification tags with the present invention.

The RFID tag may adhere to the pouch or to the individual protective garments. The RFID microchip may passively or actively transfer certain data which may include, among other things, a serial number and/or an XML message having various information identifying the products to which the RFID tags are attached. For example, the serial number may enable the information engine to update a database of information relating to inventory and utilization of the products. Each hygiene station comprising compartments containing such RFID identified products will also contain a sensor in the form of a RFID reader module. The sensor can take the form of an antenna supplying detection signals to a central RFID reader using multiplexing technology. Each compartment can be shielded using a shielding material disposed within the compartment casing, such as aluminum or other substances capable of blocking radio waves. Shielding prevents the RFID reader module from detecting any RFID tags outside of the compartment in which the reader module (sensor) is installed. Each RFID reader module is connected to the CPU either via wires or wirelessly and is thus able to communicate with the CPU. The cart can have as many RFID reader modules as it has compartments or a single reader as noted above.

In operation, the hygiene station performs the functions of taking inventory of the contents of the hygiene station, and reporting the results to the information engine. In a compliance check mode, the hygiene station contents are compared to a database. The hygiene station indicates a compliant state or a non-compliant state depending on whether the contents match the rules set forth in the operation agent. Alternatively, the necessary information may be included in the memory of the microcontroller. This latter mode requires no network connectivity, no remote computer system, and no ancillary software installed on the remote computer system. In this latter embodiment, however, the system does not take advantage of the information engine capabilities.

The information engine may be configured to enter a content query mode, and send a remote content query to the hygiene station. When the hygiene station is invoked it performs the inventory check and reports the results to the information engine. The results can be reported using the onboard LCD or other display output screen; or the results are transmitted via the network interface to the network engine, or both.

The information engine may conduct a compliance check to compare the results of the inventory check against the database. If the inventory results of the hygiene station match the database requirements, the hygiene station is deemed to be compliant. However, if the inventory results do not match the requirements set forth in the database, then the hygiene station is deemed to be non-compliant. Compliance check can be invoked using the modes described above, i.e. compliance check, remote compliance check, and passive compliance check mode.

In the event that a hygiene station is non-compliant, the information engine will communicate its state to hospital staff or other personnel by triggering an indicator as described above. The hospital staff observes the indicator and proceeds to query the hygiene station to determine any deficiency. This can be done by using the output display, or using the remote software.

### C. Hygiene Cart

Another embodiment of the present invention is the incorporation of a hygiene station in the form of a hygiene cart 103 as part of the hygiene monitoring system.

The cart according to the present invention is shown in FIGS. 10-11 and includes the hygiene station elements described above. There are many types and configurations of hygiene carts which can be used with the present invention. The hygiene cart is preferably mounted on wheels or rollers to facilitate movement of the hygiene station to various locations of the institution.

In the preferred embodiment the hygiene cart is powered by rechargeable batteries, although the cart may utilize AC and require a power connection.

### D. Hygiene Cart With Access Control

Another embodiment of the present invention is the incorporation, as part of the hygiene monitoring system, of a hygiene station in the form of a cart which additionally includes access control.

In one embodiment, access control is mediated by the information engine. In one embodiment, the access control is in communication with the hygiene cart, and as shown in FIG. 10, the access control is positioned in a location abutting the opening for entry and exit of an enclosure, such as a room, such as patient care area 101, with access control restricting movement through the opening. In another embodiment is the access control is physically part of the cart.

In another embodiment, illustrated in FIG. 11, the hygiene cart is configured to be positioned in a location abutting the opening for entry and exit of an enclosure, such as a room, such as patient care area 101, with a portion of the cart restricting movement through the opening. In one form of such embodiment, the hygiene cart comprises an access barrier section. The barrier device can be arranged either outside or inside of the room so as to restrict a person's movement through the opening. In one embodiment, the hygiene cart may incorporate an access entry system such as described in “Apparatus For Monitoring Or Controlling The Flow Of Persons Through A Gangway”, U.S. Pat. No. 7,012,244 to Huff, issued Mar. 14, 2006; or U.S. Pat. No. 7,895,791, “Passage Barrier With A Sensor Technology For Detecting The Presence Of A Person Inside The Passage Barrier” to Miller et al. issued Mar. 1, 2011; or U.S. Pat. No. 7,900,398, “Security Door System,” to Liles, issued Mar. 8, 2011. The access control may alternately comprise a turnstile (e.g., a full-body turnstile, a partial-body turnstile, a bi-directional turnstile, or a uni-directional turnstile) is employed as a barrier device. However, other barrier devices may be used to restrict a person's movement through the opening. For example, moving bars and gates, or the like may be used as a barrier device. Preferably, the access barrier section comprises a visible light beam across the opening entryway. Upon successful completion of a required hygiene regime, the light beam is terminated, indicating authorized access into the patient room.

### Advantages

A hygiene cart of the invention provides numerous advantages for promoting an institution's hygienic regime. Foremost, a hygiene carts include effective antiseptic cleaning agents. Second, generally, hand hygiene compliance has been thought to be reduced by the inconvenience of hand hygiene due to inaccessibility of sinks, towels or product dispensers. Hygiene carts of the invention render ameliorate the objection and the immediate availability of the hygiene station encourages use of antiseptic cleaning agents. Third, the automatic dispensing of the cleaning and other agents by the hygiene station further reduces the time and effort by a user and thus encourages compliance. Fourth, hygiene stations of the invention provide waterless antiseptic cleaning agents which both reduce the time required for effective cleaning, and the adverse effect on user's skin. Fifth, hygiene stations also incorporate skin emollients or protective agents either as a formulation of the antiseptic agent or as a separate ingredient. The easy availability of the protective agent reduces skin dryness and discomfort, and thus may encourage higher compliance rates compared to unprotected rinses. Although the various inconveniences are each individually factors, it is also the synergistic effect of inconveniences. The embodiments of the present invention helps alleviate the major inconveniences, and thus render it more likely that it is the combination of will increase hygienic compliance.

The advantage is maximized where the above embodiment of the invention is made available to users in conjunction with an accompanying educational program to promote the use of these agents.

### EXAMPLES

In one embodiment the system 100 comprises the structures shown above and includes the sequential steps in the monitoring process that are illustrated by the following series:

An institution, a health-care facility for illustration purposes, includes a hygiene compliance system 100. System 100 includes an internal network or intranet, which may be wired or wireless. Receivers 20 are located at selected fixed locations, and comprise both an IR sensor and RF transceiver and antenna, as well as a system-on-a-chip that incorporates a microprocessor-based microcontroller, memory and a database, the microprocessor programmed to receive and process input from any selected input devices, and to communicate with such input devices.

As shown in FIG. 10, hygiene cart 103 is located outside patient care area 101. Cart 103 includes dispensers 110A through 110E, which contain within the dispenser, respectfully, alcohol rub 110A, MRSA rub 110B, Protective agent 110C, Anti-bacterial soap 110D, and Drying agent 110E. Each dispenser 110 includes a microprocessor-based device for automatic dispensing of content when the user's hands are positioned below the dispenser valve.

Cart 103 incorporates also receiver 20C, which communicates wirelessly with bridge 30, which communicates to central server 27 which includes information engine 28. Receiver 20C incorporates an NFC device.

Upon a patient's admission, the patient is first associated with multi-modal tag 12 incorporating a system-on-a-chip and other elements to provide IR/RF and NFC communication capability. Tag 12 is programmed with:

a. Patient identification

b. Arrival time

c. Emergency indicator

At this, and all subsequent steps, the same information or data is additionally or alternately communicated to information engine 28, following standard network protocol. Thus, medical information and data relating to the patient may be continually stored in either tag 12, information engine 28, or both, in whole or in part.

Second, the patient is triaged, and a transceiver communicates data to tag 12, providing

a. Triage results

b. Updated emergence indicator

c. Steps necessary for examination.

Third, the patient examined, and a transceiver communicates data to tag 12, providing:

a. Exam results.

b. Test ordered.

c. Updated emergency indicator.

Fourth, the patient diagnosed, and a transceiver communicates data to tag 12, providing:

a. Diagnosis results

b. Care treatment/plan

c. Disposition (admit/discharge)

Fifth, the patient is treated or admitted, and a transceiver communicates data to tag 12, providing:

a. Admit info (including assignment of location of patient's patient care area 101)

b. Treatment results

c. Patient education status (discharge instructions given already or pending)

It will be recognized that the above steps are not linear or sequential. Thus, step 5c could be completed any time after step 4, or triage may indicate necessary immediate necessary steps (for example, “stitches required for wound”) so that certain steps are prioritized

The patient care area 101B to which the patient is been assigned is shown in the information engine 28 to have been previously occupied by a patient who was treated for MRSA, as primary or secondary indication. The institution requires that all users in patient care areas that had been associated with MRSA follow a specific hygienic regime. Information engine 28 identifies the patient as now being present in patient care area 101B, which now requires that all activities be associated be performed in accordance with a specified hygienic regime. The patient tag 12 may be programmed to identify the association of the patient with a MRSA-coded area.

The institution dispatches mobile cart 103 to be positioned outside patient care area 101B in view of the MRSA coding. Cart 103 incorporates an access device. The access device may be a simple electronic beam or a physical turnstile as shown in FIG. 10. A physician, nurse or other health-care worker, visitor or other user must traverse the access device to enter patient care area 101B. To traverse the device, the user must engage the access device which user can do only through tag 12, and, thus, only users associated with tag 12 can enter patient care area 101B. The institution's hygienic regime, programmed into information engine 28, provides that only selected users are allowed entry into patient care area 101B. The hygienic regime further requires certain hand hygiene before entering patient care area 101B. Upon a user approaching patient care area 101B entryway is advised to perform the required hand hygiene at cart 103. Upon the user entering dispenser area 104 in close proximity to cart 103, the NFC component of user's tag 12 communicates with NFC component of receiver 20C on cart 103. Tag 12 communicates to the users' identity to receiver 20C, and may optionally communicate the user's prior movements within the system which was stored in the database of tag 12. Receiver 20C receives the identity of the user, including the optional movement information, and communicates the user's identity to information engine 12. Information engine 28 performs a look-up to determine that the user is authorized to enter patient care area 101B. Alternatively, receiver 20C may have stored in its database the rule that any physician or nurse may enter patient care area 101B, and, upon receiving identification information from tag 12 that the bearer is a physician or nurse, recognizes the user's authority to enter patient care area 101B. On the other hand, if information engine 28 (or receiver 20C in the alternative) failed to recognize the user authorized to enter patient care area 101B, receiver 20C will not activate the hand hygiene sequence, and will by audible signal (for example, “entry denied”) or a red flashing light, emanating from receiver 20C or another device associated with receiver 20C, inform the user that the user is not authorized to enter patient care area 101B.

Upon recognizing the user as authorized to enter patient care area 101B, the system will begin the hand hygiene sequence. The sequence can initiate and continue only so long as the user is within area 104, which is an area in close proximity to the cart. The system will recognize that user is within area 104 by the fact that the user's tag and receiver 20C remain in continuous NFC communication. A speaker associated with alternately receiver 20C or cart 103 will direct the user to initiate the hand hygiene sequence by performing the first hand hygiene step. Alternately, rather than audio, the system may designate the initiation and first step by blinking a light next to the valve of the first dispenser. Subsequent steps are directed by audio signals or by blinking lights. In this example, the user is directed to employ MRSA rub in dispenser 110B. To continue the sequence, user must place the user's hands under the dispensing valve of dispenser 110B. The microprocessor within the dispenser communicates to receiver 20C and then to information engine 28 that a user's hands had been positioned under the dispenser valve of dispenser 110B, and that a quantity of MRSA rub was dispensed. The system associates the activity with the user, because the NFC communication between user's tag 12 and receiver 20C has been continuous.

The NFC component of the user's tag interacts with receiver 20B, which interacts with the microcontroller of the hygienic station 103. The user's approach to the hygiene cart, with receiver 20B in sufficient proximity that the user's NFC tag to interact, the two devices' proximity results in a short range communication transceiver of one of the NFC devices transmitting a command to the processor of the other NFC device that an interaction has occurred between NFC devices. The processor sends the data from the interaction to a medium range communication transceiver of the NFC receiver, which transmits the data to another receiver on the network. The receiver preferably transmits the signal through the network to a bridge 30 for further transmission to information engine 28. Receiver 20C recognizes the user's identity. The receiver issues a visual or auditory signal indicating to the user that the user has been recognized. When the users perform hand hygiene at the hygiene station, the NFC interaction is received by the receiver, recorded and transmitted to the information engine 28. In this manner, the hospital has a record to demonstrate that proper sterilization was performed prior to any covered activity.

Because of the stringent nature of the MRSA rub, the user is required to also apply a protective agent as part of the sequence. The protective agent is dispensed in the same fashion as the MRSA rub. However, the protective agent sequence cannot begin prior to a passage of a time. Thus, user will continue applying MRSA rub to the user's hands, until such time as a signal is given to place the user's hands under the dispensing valve for the dispenser containing the protective agent. The access device will allow entry in patient care area 101B only upon the sequential completion of all the steps required by the hygienic regime. Only the user who had completed the sequence is authorized to enter. The user is recognized in patient care area 101B, because the IR/RF signals of tag 12 are received by receiver 20 in patient care area 101B. An alarm will issue if receiver 20 recognizes a signal identifying a tag that had not been authorized by the proper completion of the hygienic regime. The user is designated as user A. A second user B follows user A in completing the hygiene sequence and also enters patient care area 101B.

User A enters patient care area 101B, but is not in close proximity to the patient and is in the room only a period of time that is less than a trigger point established by the hygienic regime. User A exits patient care area 101B. The exit is recognized by any one or more of the combination of signals being received by receivers 20 within patient care area 101B and those outside patient care area 101B. Additionally, the entry point into patient care area 101B may include receiver 20 incorporating a sensor sensitive to movement through the portal between patient care area 101B and the area outside. Because user A did not approach the patient area and did not stay in patient care area 101B beyond the trigger point, the hygiene regime does not require that user A perform hand hygiene upon exiting.

User A continues immediately to an adjacent patient care area, also within the MRSA regime area. However, under the institution's hygiene regime, user A need not repeat the hand hygiene process, because the receivers associated with the entry to the patient care area recognize that user A had performed hand hygiene within a determinate time period prior to entry, and had not been exposed to a contamination area.

User B upon entry into patient care area 101B approached the patient. The NFC component of the user B's tag interacts with tag 12 associated with the patient. The interaction causes user B's tag to emit an IR, RF or IT/RF signal, which is received by Receiver 20. Information engine 28 recognizes that user B has now moved into an area designated as an area of potential contamination.

The NFC interaction between user B's tag and the patient's tag allows user B to confirm the identity of the patient and download other information such as the time and length of prior interactions between the patient and any tag, and the identity of the tag owner. For example, user B may have available a personal digital assistant (PDA) or a telecommunication device, each including an NFC component and programmed to receive an NFC interaction signal from the patient's tag or user B's tag which authorizes the transfer of information stored in memory or in the database of the patient's tag to the PDA or telecommunication device. For example, the transmission from the patient's tag may include a picture of the patient taken at time of admission that confirms the patient's identity. User B may also be authorized to determine whether health-care workers had devoted the time with the patient to perform the necessary medical procedures and when such events took place.

Upon attempting to exit patient care area 101B, hygiene cart emits a signal (such as auditory or by blinking lights) to advise user B that user B is required to again perform hand hygiene under the rules prescribed by the hygiene regime of the institution. User B approaches area 104 associated with cart 103, and the hand hygiene process is again initiated and performed as before, although a different sequence of events may be prescribed for exiting the area rather than entering patient care area 101B.

In another institution, the system employs a tracking system comprising 2D or Flash LADAR imaging systems or cameras incorporated into receivers 20. User tag 12 identifies the user. The cameras in receivers 20 infer the users' or objects' motion by analyzing each video frame based on prior appearance. A currently-available behavioral recognition program is programmed to interpret the user's motion. The programming allows the pixel's produced by the user's actions to infer the user's actions, including actions within the patient care area and whether the user had performed the required hygienic steps.

The foregoing and other aspects of the invention that will become apparent as the detailed description proceeds are achieved by an online method for improving individual hand hygiene practices within an institution, comprising: individually interconnecting a participant's internet communication device with a program manager, said program manager having a processing unit and software for interactive communication with the participant; uniquely logging said participant into said interactive communication; sequentially engaging in a plurality of sessions of self-assessment by said participant of hand hygiene practices and development of hand hygiene self-improvement plans based thereon, said sessions being controlled by said program manager; and effecting communications between said program manager and said participant between said sessions to implement said hand hygiene self-improvement plans.

What is claimed is:

1. A networked method for improving hygiene practices within an institution, comprising:
providing for communication between a tag and a receiver, where the receiver is in communication with a network for transmission of data to an information engine;
monitoring whether a user has sequentially engaged in a plurality of hygiene practices,
wherein the communication between the tag and receiver comprises
receiving a communication from a near-field communication device for providing identification information and for sequencing hygienic events;

2. A system of claim 1, in which at least one near-field communication devices is associated with a hygiene station.

3. A system of claim 2, in which the hygiene station is portable.

4. A system of claim 2, in which the hygiene station incorporates access control to a predefined physical area.

5. B. receiving a communication from a near-field communication device for providing identification information, where the receiver is associated with a movable hygiene station;

6. A system of claim 1, in which at least one near-field communication devices is a telephone.

7. A movable hygiene cart networked to a system for improving hygiene practices within an institution, comprising:
a near-field communication receiver, where the receiver is in communication with a network for transmission of data to an information engine.

8. A cart of claim 7 further comprising:
automatic dispensers comprising cleaning agents and protective agents;
wherein the dispensers are each linked to an information engine for determining the sequence of dispensing the cleaning agents and protective agents.
